(19) United States
(12) Patent Application Publication
(10) Pub. No.: US 2026/0230670 A1
(43) Pub. Date: Aug. 6, 2026

(54) IMAGE DISPLAY APPARATUS

(71) Applicant: LG ELECTRONICS INC., Seoul (KR)

(72) Inventors: Wontak Jeon, Seoul (KR); Hyeseung Lee, Seoul (KR); June Choi, Seoul (KR); Kyungryun Lee, Seoul (KR)

(73) Assignee: LG ELECTRONICS INC., Seoul (KR)

(21) Appl. No.: 19/530,760

(22) Filed: Feb. 5, 2026

(30) Foreign Application Priority Data
Feb. 6, 2025 (WO) PCT/KR2025/001745

(51) Int. Cl. H04N 21/439; H04N 21/43; H04N 21/4363

(52) U.S. Cl. CPC H04N 21/4394; H04N 21/43072; H04N 21/43635; H04N 21/4396

(57) ABSTRACT

An image display apparatus comprises a display, an audio output device, an interface to receive signal from an external sound output device, and a signal processing device to display a first image based on a first video signal from the sound output device and output a first sound to the audio output device based on a first audio signal from the sound output device, wherein in response to the external input mode being switched, the signal processing device is configured to display a second image, output a second sound to the audio output device based on the transition to the external input mode, and transmit a third audio signal or a mute signal to the sound output device. Accordingly, it is possible to reduce sense of discrepancy caused by other sounds from the sound output device or the settop device when the image display apparatus outputs sound.

### BACKGROUND

### Field

The present disclosure relates to an image display apparatus, and more particularly, to an image display apparatus capable of reducing a sense of discrepancy caused by other sounds from a sound output device or a settop device when the image display apparatus outputs sound.

### Description of the Related Art

An image display apparatus is an apparatus that displays images.

Meanwhile, when a video is displayed on an image display apparatus, sounds corresponding to the video are output.

With the demand for rich sound experiences, the image display apparatus is increasing its output power when outputting sounds, and furthermore, the use of a separate sound output device is also increasing.

However, while the sound output device and the image display apparatus output sounds simultaneously, if an external input of the image display apparatus is changed, the image display apparatus and the sound output device output sounds corresponding to their respective contents; consequently, this results in a sense of discrepancy due to the different sounds from the image display apparatus and the sound output device.

### SUMMARY

An object of the present disclosure is to provide an image display apparatus capable of reducing the sense of discrepancy caused by other sounds from a sound output device or a settop device when the image display apparatus outputs sound.

Meanwhile, another object of the present disclosure is to provide an image display apparatus capable of outputting stable sounds when the image display apparatus outputs sound independently.

To achieve the objects above, an image display apparatus according to one embodiment of the present disclosure comprises a display, an audio output device configured to output sound, an interface configured to receive signal from an external sound output device, and a signal processing device configured to display a first image on the display based on a first video signal received from the sound output device and output a first sound to the audio output device based on a first audio signal received from the sound output device, wherein in response to the external input mode being switched, the signal processing device is configured to display a second image on the display based on a second image signal received based on the transition to the external input mode, output a second sound to the audio output device based on a second audio signal received based on the transition to the external input mode, and transmit a third audio signal or a mute signal to the sound output device.

Meanwhile, in response to the external input mode being switched to a simultaneous sound output mode with the sound output device, the signal processing device can be configured to transmit a third audio signal corresponding to the second audio signal to the sound output device.

Meanwhile, the interface can be wired to the sound output device via an HDMI interface, receive a first video signal and a first audio signal from the sound output device in a first input mode, and transmit the third audio signal or the mute signal to the sound output device in a second input mode to which the external input mode has been switched.

Meanwhile, the interface can be wired to the sound output device via an HDMI interface, receive the first video signal and the first audio signal from the sound output device through a plurality of Transition Minimized Differential Signaling (TMDS) lanes in the first input mode, and transmit the third audio signal or the mute signal to the sound output device through a subset of the plurality of TMDS lanes or a utility line in the second input mode to which the external input mode has been switched.

Meanwhile, the interface can be wired to the sound output device via an HDMI interface, receive the first video signal and the first audio signal from the sound output device through a plurality of Fixed Rate Link (FRL) lanes in the first input mode, and transmit the third audio signal or the mute signal to the sound output device through a subset of the plurality of FRL lanes or a utility line in the second input mode to which the external input mode has been switched.

Meanwhile, the interface can be configured to receive information on the sound output device through a CEC line in response to the sound output device being powered on.

Meanwhile, in response to the external input mode being switched, the signal processing device can be configured to transmit the mute signal to the sound output device in response to the image display apparatus being in a standalone sound output mode or in response to transmission of an audio return channel signal to the sound output device being not possible.

Meanwhile, the interface can include a first HDMI terminal and a second HDMI terminal, the first HDMI terminal can be configured to receive the first video signal and the first audio signal from the sound output device in the first input mode, and the second HDMI terminal can be configured to receive the second image signal and the second audio signal from a connected external device in the second input mode to which the external input mode has been switched.

Meanwhile, in the second input mode, in response to the simultaneous sound output mode with the sound output device being set and signal transmission via the audio return channel to the sound output device being possible, the first HDMI terminal can be configured to transmit the third audio signal corresponding to the second audio signal to the sound output device.

Meanwhile, in the second input mode, in response to a common sound output mode being set, the signal processing device can be configured to control the image display apparatus, the sound output device, and the external device to output sound respectively; in the second input mode, in response to a first simultaneous sound output mode being set, the signal processing device can be configured to control the image display apparatus and the external device to output sound respectively; and in the second input mode, in response to a second simultaneous sound output mode being set, the signal processing device can be configured to control the image display apparatus and the sound output device to output sound respectively.

Meanwhile, the interface can include a first HDMI terminal configured to support an audio return channel and a second HDMI terminal configured to not support the audio return channel; in response to an external device being connected to the first HDMI terminal and the sound output device is connected to the second HDMI terminal, in the first input mode, the first HDMI terminal can be configured to receive the first video signal and the first audio signal from the sound output device through the second HDMI terminal; and in the second input mode to which the external input mode has been switched, the first HDMI terminal can be configured to receive the second image signal and the second audio signal from a connected external device, while the second HDMI terminal can not transmit the third audio signal or the mute signal to the sound output device.

An image display apparatus according to another embodiment of the present disclosure comprises a display, an audio output device configured to output sound, an interface configured to receive signal from an external sound output device, and a signal processing device configured to display a first image on the display based on a first video signal received from a settop device and output a first sound to the audio output device based on a first audio signal received from the settop device, wherein in response to the external input mode being switched, the signal processing device is configured to display a second image on the display based on a second image signal received based on the transition to the external input mode, output a second sound to the audio output device based on a second audio signal received based on the transition to the external input mode, and transmit a mute signal to the settop device or the sound output device connected to the settop device.

Meanwhile, the interface can be wired to the settop device via an HDMI interface, receive the first video signal and the first audio signal from the settop device in a first input mode, and transmit the mute signal to the settop device in a second input mode to which the external input mode has been switched.

Meanwhile, the interface can be wired to the settop device via an HDMI interface, receive the first video signal and the first audio signal from the settop device through a plurality of Transition Minimized Differential Signaling (TMDS) lanes in the first input mode, and transmit the mute signal to the settop device through a subset of the plurality of TMDS lanes or a utility line in the second input mode to which the external input mode has been switched.

Meanwhile, the interface can be wired to the settop device via an HDMI interface, receive the first video signal and the first audio signal from the settop device through a plurality of Fixed Rate Link (FRL) lanes in the first input mode, and transmit the mute signal to the settop device through a subset of the plurality of FRL lanes or a utility line in the second input mode to which the external input mode has been switched.

Meanwhile, the interface can be configured to receive information on the settop device through a CEC line in response to the settop device being powered on.

Meanwhile, the interface can include a first HDMI terminal and a second HDMI terminal, the first HDMI terminal can be configured to receive the first video signal and the first audio signal from the settop device in the first input mode, and the second HDMI terminal can be configured to receive the second image signal and the second audio signal from a connected external device in the second input mode to which the external input mode has been switched.

Meanwhile, the interface can include a first HDMI terminal configured to support an audio return channel and a second HDMI terminal configured to not support the audio return channel; in response to an external device being connected to the first HDMI terminal and the settop device is connected to the second HDMI terminal, in the first input mode, the first HDMI terminal can be configured to receive the first video signal and the first audio signal from the settop device through the second HDMI terminal; and in the second input mode to which the external input mode has been switched, the first HDMI terminal can be configured to receive the second image signal and the second audio signal from a connected external device, while the second HDMI terminal can not transmit the third audio signal or the mute signal to the settop device.

### BRIEF DESCRIPTION OF THE DRAWINGS

FIG. 1 is a diagram showing an image display system according to one embodiment of the present disclosure.

FIG. 2 is an example of an internal block diagram of the image display apparatus of FIG. 1.

FIG. 3 is an example of an internal block diagram of a signal processing device of FIG. 2.

FIG. 4A is a diagram showing a method of controlling a remote controller of FIG. 2.

FIG. 4B is an internal block diagram of the remote controller of FIG. 2.

FIG. 5 is an example of an internal block diagram of the sound output device of FIG. 1.

FIG. 6 is an example of an internal block diagram of an image display apparatus due to connection to an external device.

FIGS. 7A to 7E are diagrams referred to in the description of FIG. 6.

FIGS. 8A to 8C illustrate various interfaces between the image display apparatus and an external device according to an embodiment of the present disclosure.

FIG. 9 is an example of a method for operating the image display apparatus according to an embodiment of the present disclosure.

FIGS. 10A to 11D are diagrams referred to in the description of FIG. 9.

FIG. 12 is an example of a method for operating the image display apparatus according to another embodiment of the present disclosure.

FIGS. 13A to 13C are diagrams referred to in the description of FIG. 12.

FIGS. 14A to 14D are diagrams referred to in the description of FIGS. 9 or 12.

### DETAILED DESCRIPTION OF THE PREFERRED EMBODIMENTS

Hereinafter, the present disclosure will be described in detail with reference to the accompanying drawings.

Regarding constituent elements used in the following description, suffixes “module” and “unit” are given only in consideration of ease in the preparation of the specification, and do not have or serve as different meanings. Accordingly, the suffixes “module” and “unit” can be used interchangeably.

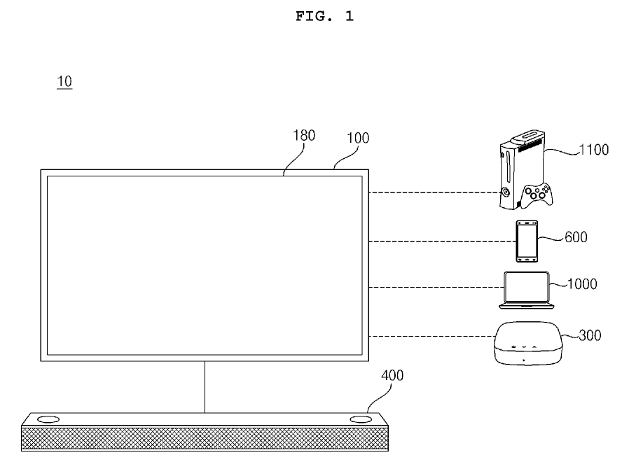

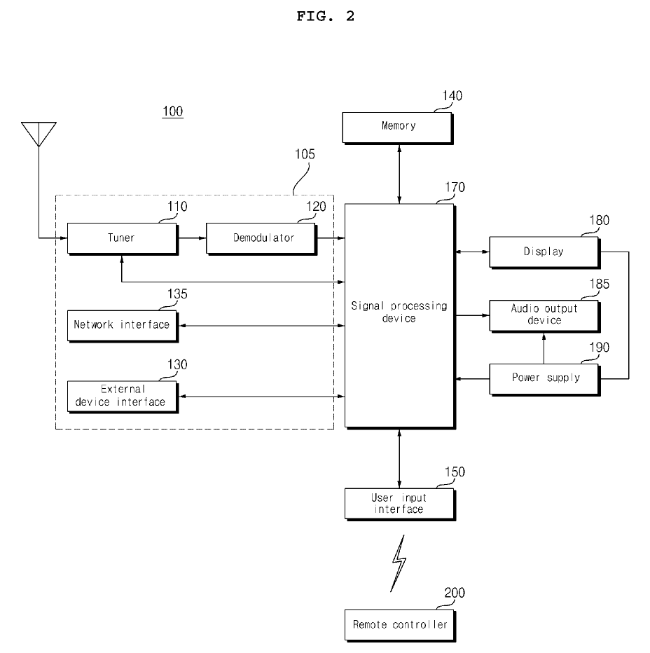

FIG. 1 is a diagram showing an image display system according to one embodiment of the present disclosure.

Referring to the figure, an image display system 10 according to one embodiment of the present disclosure includes an image display apparatus 100 equipped with a display 180 and a sound output device 400.

Meanwhile, the image display system 10 can further include an external device 300, 600, 1000, or 1100.

In this case, the external device 300, 400, 600, 1000, or 1100 can include one of a settop device 300, a mobile terminal 600, a laptop computer 1000, or a game console 1100.

The image display apparatus 100 according to one embodiment of the present disclosure can display an image and output a sound based on an image signal and an audio signal received from the sound output device 400.

Meanwhile, while displaying an image and outputting sound based on an image signal and an audio signal received from the sound output device 400, if the external input mode is switched and a second image signal and a second audio signal are received from one of the external devices 300, 400, 600, 1000, or 1100, the image display apparatus 100 according to one embodiment of the present disclosure can display a second video and output a second sound based on the image signal and audio signal received from the external device 300, 400, 600, 1000, or 1100.

At this case, it is preferable that the sound output device 400 either outputs sound corresponding to the second sound output from the image display apparatus 100 or mutes the sound. Accordingly, when the image display apparatus outputs sound, the sense of discrepancy caused by other sounds from the sound output device can be reduced.

Meanwhile, the display 180 within the image display apparatus 100 can be implemented using various types of panels. For example, the display 180 can be one of a liquid crystal display (LCD) panel, an organic light-emitting diode (OLED) panel, or an inorganic light-emitting diode (LED) panel.

Meanwhile, the image display apparatus 100 of FIG. 1 can be a TV, a monitor, a tablet PC, or a mobile terminal.

FIG. 2 is an example of an internal block diagram of the image display apparatus of FIG. 1.

Referring to FIG. 2, the image display apparatus 100 according to one embodiment of the present disclosure can include an image receiver 105, an external device interface 130, a memory 140, a user input interface 150, a sensor device (not shown), a signal processing device 170, a display 180, and an audio output device 185.

The image receiver 105 can include a tuner 110, a demodulator 120, a network interface 135, and an external apparatus interface 130.

Meanwhile, unlike the figure, the image receiver 105 can include only the tuner 110, the demodulator 120, and the external device interface 130. That is, the network interface 135 can not be included.

The tuner 110 selects an RF broadcast signal corresponding to a channel selected by a user or all pre-stored channels among radio frequency (RF) broadcast signals received through an antenna (not shown). In addition, the selected RF broadcast signal is converted into an intermediate frequency signal, a baseband image, or an audio signal.

For example, if the selected RF broadcast signal is a digital broadcast signal, the tuner 110 converts the digital broadcast signal into a digital IF (DIF) signal and, if the selected RF broadcast signal is an analog broadcast signal, the tuner 110 converts the analog broadcast signal into an analog baseband image or voice (CVBS/SIF) signal. That is, the tuner 110 can process a digital broadcast signal or an analog broadcast signal. The analog baseband image or voice (CVBS/SIF) signal output from the tuner 110 can be directly input to the signal processing device 170.

Meanwhile, the tuner 110 can include a plurality of tuners for receiving broadcast signals of a plurality of channels. Alternatively, a single tuner that simultaneously receives broadcast signals of a plurality of channels is also available.

The demodulator 120 receives the converted digital IF signal DIF from the tuner 110 and performs a demodulation operation.

The demodulator 120 can perform demodulation and channel decoding and then output a stream signal TS. At this time, the stream signal can be a multiplexed signal of an image signal, an audio signal, or a data signal.

The stream signal output from the demodulator 120 can be input to the signal processing device 170. The signal processing device 170 performs demultiplexing, image or audio signal processing, and the like, and then outputs an image to the display 180 and outputs audio to the audio output device 185.

The external device interface 130 can be configured to transmit or receive data with a connected external apparatus (not shown), e.g., a settop box 50. To this end, the external device interface 130 can include an A/V input and output device (not shown).

The external device interface 130 can be connected in wired or wirelessly to an external apparatus, such as a digital versatile disk (DVD), a Blu ray, a game equipment, a camera, a camcorder, a computer (note book), and a settop box, and can perform an input or output operation with an external apparatus.

The A/V input and output device can be configured to receive image and audio signals from an external apparatus. Meanwhile, a wireless transceiver (not shown) can perform short-range wireless communication with other electronic apparatus.

Through the wireless transceiver (not shown), the external device interface 130 can exchange data with an adjacent mobile terminal 600. In particular, in a mirroring mode, the external device interface 130 can be configured to receive device information, executed application information, application image, and the like from the mobile terminal 600.

The network interface 135 provides an interface for connecting the image display apparatus 100 to a wired or wireless network including the Internet network. For example, the network interface 135 can be configured to receive, via the network, content or data provided by the Internet, a content provider, or a network operator.

Meanwhile, the network interface 135 can include a wireless transceiver (not shown).

The memory 140 can store a program for each signal processing and control in the signal processing device 170, and can store signal-processed image, audio, or data signal.

In addition, the memory 140 can serve to temporarily store image, audio, or data signal input to the external device interface 130. In addition, the memory 140 can store information on a certain broadcast channel through a channel memory function, such as a channel map.

Although FIG. 2 illustrates that the memory is provided separately from the signal processing device 170, the scope of the present disclosure is not limited thereto. The memory 140 can be included in the signal processing device 170.

The user input interface 150 transmits a signal input by the user to the signal processing device 170 or transmits a signal from the signal processing device 170 to the user.

For example, the user input interface 150 can be configured to transmit or receive a user input signal, such as power on/off, channel selection, screen setting, and the like from a remote controller 200; can send a user input signal input from a local key (not shown), such as a power key, a channel key, a volume key, a set value, and the like to the signal processing device 170; can send a user input signal input from a sensor device (not shown) that senses a user's gesture to the signal processing device 170; or can be configured to transmit a signal from the signal processing device 170 to the sensor device (not shown).

The signal processing device 170 can demultiplex the input stream through the tuner 110, the demodulator 120, the network interface 135, or the external device interface 130, or process the demultiplexed signals to generate and output a signal for image or audio output.

For example, the signal processing device 170 receives a broadcast signal received by the image receiver 105 or an HDMI signal, and perform signal processing based on the received broadcast signal or the HDMI signal to thereby output a processed image signal.

The image signal processed by the signal processing device 170 is input to the display 180, and can be displayed as an image corresponding to the image signal. In addition, the image signal processed by the signal processing device 170 can be input to the external device through the external device interface 130.

The audio signal processed by the signal processing device 170 can be output to the audio output device 185 as an audio signal. In addition, audio signal processed by the signal processing device 170 can be input to the external device through the external device interface 130.

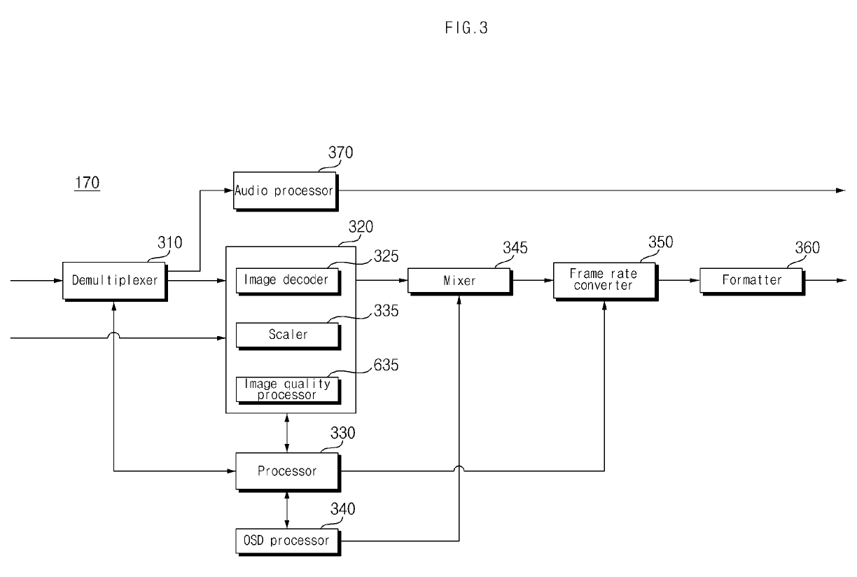

Although not shown in FIG. 2, the signal processing device 170 can include a demultiplexer, an image processor, and the like. That is, the signal processing device 170 can perform a variety of signal processing and thus it can be implemented in the form of a system on chip (SOC). This will be described later with reference to FIG. 3.

In addition, the signal processing device 170 can be configured to control the overall operation of the image display apparatus 100. For example, the signal processing device 170 can be configured to control the tuner 110 to control the tuning of the RF broadcast corresponding to the channel selected by the user or the previously stored channel.

In addition, the signal processing device 170 can be configured to control the image display apparatus 100 according to a user command input through the user input interface 150 or an internal program.

Meanwhile, the signal processing device 170 can be configured to control the display 180 to display an image. At this time, the image displayed on the display 180 can be a still image or a moving image, and can be a 2D image or a 3D image.

Meanwhile, the signal processing device 170 can display a certain object in an image displayed on the display 180. For example, the object can be at least one of a connected web screen (newspaper, magazine, etc.), an electronic program guide (EPG), various menus, a widget, an icon, a still image, a moving image, and a text.

Meanwhile, the signal processing device 170 can recognize the position of the user based on the image photographed by a photographing device (not shown). For example, the distance (z-axis coordinate) between a user and the image display apparatus 100 can be determined. In addition, the x-axis coordinate and the y-axis coordinate in the display 180 corresponding to a user position can be determined.

The display 180 generates a driving signal by converting an image signal, a data signal, an OSD signal, a control signal processed by the signal processing device 170, an image signal, a data signal, a control signal, and the like received from the external device interface 130.

Meanwhile, the display 180 can be configured as a touch screen and used as an input device in addition to an output device.

The audio output device 185 receives a signal processed by the signal processing device 170 and outputs it as an audio.

The photographing device (not shown) photographs a user. The photographing device (not shown) can be implemented by a single camera, but the present disclosure is not limited thereto and can be implemented by a plurality of cameras. Image information photographed by the photographing device (not shown) can be input to the signal processing device 170.

The signal processing device 170 can sense a gesture of the user based on each of the images photographed by the photographing device (not shown), the signals detected from the sensor device (not shown), or a combination thereof.

The power supply 190 supplies corresponding power to the image display apparatus 100. Particularly, the power can be supplied to a signal processing device 170 which can be implemented in the form of a system on chip (SOC), a display 180 for displaying an image, and an audio output device 185 for outputting an audio.

Specifically, the power supply 190 can include a converter converting AC power to DC voltage and a DC/DC converter converting the level of the DC voltage.

The remote controller 200 transmits the user input to the user input interface 150. To this end, the remote controller 200 can use Bluetooth, a radio frequency (RF) communication, an infrared (IR) communication, an Ultra Wideband (UWB), ZigBee, or the like. In addition, the remote controller 200 can be configured to receive the image, audio, or data signal output from the user input interface 150 and display it on the remote controller 200 or output it as an audio.

Meanwhile, the image display apparatus 100 can be a fixed or mobile digital broadcast receiver capable of receiving digital broadcast.

Meanwhile, a block diagram of the image display apparatus 100 shown in FIG. 2 is a block diagram for an embodiment of the present disclosure. Each component of the block diagram can be integrated, added, or omitted according to a specification of the image display apparatus 100 actually implemented. That is, two or more components can be combined into a single component as needed, or a single component can be split into two or more components. The function performed in each block is described for the purpose of illustrating embodiments of the present disclosure, and specific operation and apparatus do not limit the scope of the present disclosure.

FIG. 3 is an example of an internal block diagram of the signal processing device in FIG. 2.

Referring to the figure, the signal processing device 170 according to an embodiment of the present disclosure can include a demultiplexer 310, an image processor 320, a processor 330, and an audio processor 370. In addition, the signal processing device 170 can further include and a data processor (not shown).

The demultiplexer 310 demultiplexes the input stream. For example, in case in which an MPEG-2 TS is input, it can be demultiplexed into image, audio, and data signal, respectively. Here, the stream signal input to the demultiplexer 310 can be a stream signal output from the tuner 110, the demodulator 120, or the external device interface 130.

The image processor 320 can perform signal processing on an input image. For example, the image processor 320 can perform image processing on an image signal demultiplexed by the demultiplexer 310.

To this end, the image processor 320 can include an image decoder 325, a scaler 335, an image quality processor 635, an image encoder (not shown), an OSD processor 340, a frame rate converter 350, a formatter 360, etc.

The image decoder 325 decodes a demultiplexed image signal, and the scaler 335 performs scaling so that the resolution of the decoded image signal can be output from the display 180.

The image decoder 325 can include a decoder of various standards. For example, a 3D image decoder for MPEG-2, H.264 decoder, a color image, and a depth image, and a decoder for a multiple view image can be provided.

The scaler 335 can scale an input image signal decoded by the image decoder 325 or the like.

For example, if the size or resolution of an input image signal is small, the scaler 335 can upscale the input image signal, and, if the size or resolution of the input image signal is great, the scaler 335 can downscale the input image signal.

The image quality processor 635 can perform image quality processing on an input image signal decoded by the image decoder 325 or the like.

For example, the image quality processor 635 can perform noise reduction processing on an input image signal, extend the gray scale resolution of an input image signal, perform image resolution enhancement, perform high dynamic range (HDR)-based signal processing, change a frame rate, or perform image quality processing relevant to the panel characteristics.

The OSD processor 340 generates an OSD signal according to a user input or by itself. For example, based on a user input signal, the OSD processor 340 can generate a signal for displaying various information as a graphic or a text on the screen of the display 180. The generated OSD signal can include various data, such as a user interface screen of the image display apparatus 100, various menu screens, a widget, and an icon. In addition, the generated OSD signal can include a 2D object or a 3D object.

In addition, the OSD processor 340 can generate a pointer that can be displayed on the display, based on a pointing signal input from the remote controller 200. In particular, such a pointer can be generated by a pointing signal processing device, and the OSD processor 340 can include such a pointing signal processing device (not shown). Obviously, the pointing signal processing device (not shown) can be provided separately from the OSD processor 340.

The frame rate converter (FRC) 350 can convert a frame rate of an input image. Meanwhile, the frame rate converter 350 can output the input image without converting the frame rate.

Meanwhile, the formatter 360 can change a format of an input image signal into a format suitable for displaying the image signal on a display and output the image signal in the changed format.

In particular, the formatter 360 can change a format of an image signal to correspond to a display panel.

Further, the formatter 360 can convert the format of an image signal. For example, the formatter 360 can convert the format of a 3D image signal into one of various 3D formats, including a side-by-side format, a top/down format, a frame sequential format, an interlaced format, a checker box format, etc.

The processor 330 can be configured to control overall operations of the image display apparatus 100 or the signal processing device 170.

For example, the processor 330 can be configured to control the tuner 110 to control the tuning of an RF broadcast corresponding to a channel selected by a user or a previously stored channel.

In addition, the processor 330 can be configured to control the image display apparatus 100 according to a user command input through the user input interface 150 or an internal program.

In addition, the processor 330 can be configured to transmit data to the network interface 135 or to the external device interface 130.

In addition, the processor 330 can be configured to control the demultiplexer 310, the image processor 320, and the like in the signal processing device 170.

Meanwhile, the audio processor 370 in the signal processing device 170 can perform the audio processing of the demultiplexed audio signal. To this end, the audio processor 370 can include various decoders.

In addition, the audio processor 370 in the signal processing device 170 can process a base, a treble, a volume control, and the like.

The data processor (not shown) in the signal processing device 170 can perform data processing of the demultiplexed data signal. For example, in case in which the demultiplexed data signal is a coded data signal, it can be decoded. The encoded data signal can be electronic program guide information including broadcast information, such as a start time and an end time of a broadcast program broadcasted on each channel.

Meanwhile, a block diagram of the signal processing device 170 shown in FIG. 3 is a block diagram for an embodiment of the present disclosure. Each component of the block diagram can be integrated, added, or omitted according to a specification of the signal processing device 170 actually implemented.

In particular, the frame rate converter 350 and the formatter 360 can be provided separately in addition to the image processor 320.

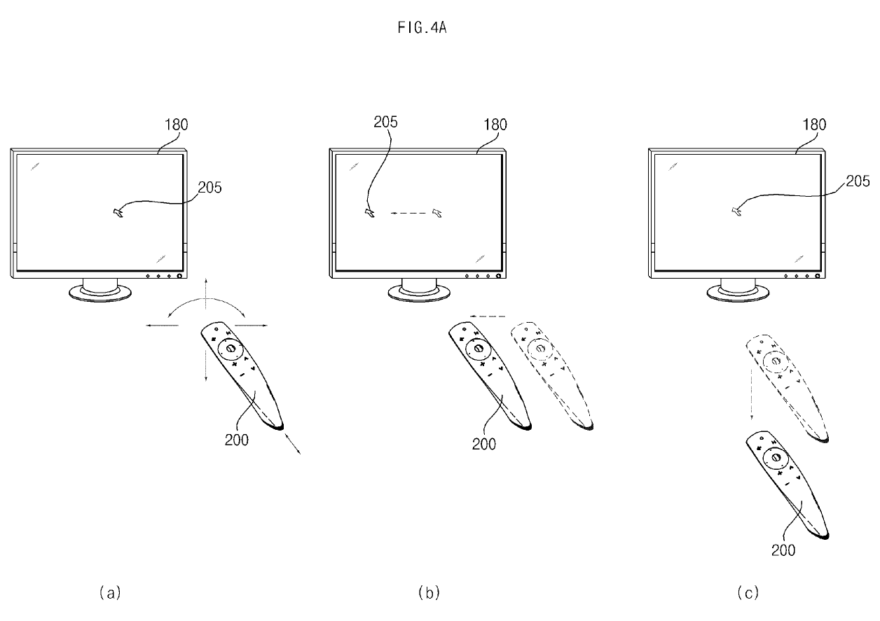

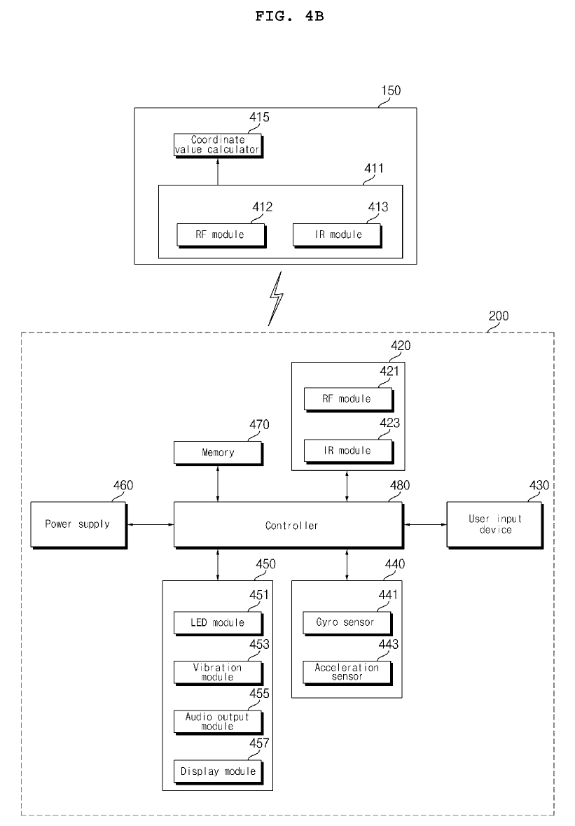

FIG. 4A is a diagram illustrating a control method of a remote controller of FIG. 2.

As shown in FIG. 4A(a), it is illustrated that a pointer 205 corresponding to the remote controller 200 is displayed on the display 180.

The user can move or rotate the remote controller 200 up and down, left and right (FIG. 4A(b)), and back and forth (FIG. 4A(c)). The pointer 205 displayed on the display 180 of the image display apparatus corresponds to the motion of the remote controller 200. Such a remote controller 200 can be referred to as a space remote controller or a 3D pointing apparatus, because the pointer 205 is moved and displayed according to the movement in a 3D space, as shown in the figure.

FIG. 4A(b) illustrates that in case in which the user moves the remote controller 200 to the left, the pointer 205 displayed on the display 180 of the image display apparatus also moves to the left correspondingly.

Information on the motion of the remote controller 200 detected through a sensor of the remote controller 200 is transmitted to the image display apparatus. The image display apparatus can calculate the coordinate of the pointer 205 from the information on the motion of the remote controller 200. The image display apparatus can display the pointer 205 to correspond to the calculated coordinate.

FIG. 4A(c) illustrates a case where the user moves the remote controller 200 away from the display 180, while pressing a specific button of the remote controller 200. Thus, a selection area within the display 180 corresponding to the pointer 205 can be zoomed in so that it can be displayed to be enlarged. Meanwhile, in case in which the user moves the remote controller 200 close to the display 180, the selection area within the display 180 corresponding to the pointer 205 can be zoomed out so that it can be displayed to be reduced. Meanwhile, in case in which the remote controller 200 moves away from the display 180, the selection area can be zoomed out, and in case in which the remote controller 200 approaches the display 180, the selection area can be zoomed in.

Meanwhile, in case in which the specific button of the remote controller 200 is pressed, it is possible to exclude the recognition of vertical and lateral movement. That is, in case in which the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state where the specific button of the remote controller 200 is not pressed.

Meanwhile, the moving speed or the moving direction of the pointer 205 can correspond to the moving speed or the moving direction of the remote controller 200.

FIG. 4B is an internal block diagram of the remote controller of FIG. 2.

Referring to the figure, the remote controller 200 includes a wireless transceiver 425, a user input device 435, a sensor device 440, an output device 450, a power supply 460, a memory 470, and a controller 480.

The wireless transceiver 425 transmits or receives a signal to or from any one of the image display apparatuses according to the embodiments of the present disclosure described above. Among the image display apparatuses according to the embodiments of the present disclosure, one image display apparatus 100 will be described as an example.

In the present embodiment, the remote controller 200 can include an RF module 421 for transmitting and receiving signals to and from the image display apparatus 100 according to a RF communication standard. In addition, the remote controller 200 can include an IR module 423 for transmitting and receiving signals to and from the image display apparatus 100 according to a IR communication standard.

In the present embodiment, the remote controller 200 transmits a signal containing information on the motion of the remote controller 200 to the image display apparatus 100 through the RF module 421.

In addition, the remote controller 200 can be configured to receive the signal transmitted by the image display apparatus 100 through the RF module 421. In addition, if necessary, the remote controller 200 can be configured to transmit a command related to power on or off, channel change, volume change, and the like to the image display apparatus 100 through the IR module 423.

The user input device 435 can be implemented by a keypad, a button, a touch pad, a touch screen, or the like. The user can operate the user input device 435 to input a command related to the image display apparatus 100 to the remote controller 200. When the user input device 435 includes a hard key button, the user can input a command related to the image display apparatus 100 to the remote controller 200 through a push operation of the hard key button. When the user input device 435 includes a touch screen, the user can touch a soft key of the touch screen to input the command related to the image display apparatus 100 to the remote controller 200. In addition, the user input device 435 can include various types of input means, such as a scroll key, a jog key, etc., which can be operated by the user, and the present disclosure does not limit the scope of the present disclosure.

The sensor device 440 can include a gyro sensor 441 or an acceleration sensor 443. The gyro sensor 441 can sense information regarding the motion of the remote controller 200.

For example, the gyro sensor 441 can sense information on the operation of the remote controller 200 based on the x, y, and z axes. The acceleration sensor 443 can sense information on the moving speed of the remote controller 200. Meanwhile, a distance measuring sensor can be further provided, and thus, the distance to the display 180 can be sensed.

The output device 450 can output an image or an audio signal corresponding to the operation of the user input device 435 or a signal transmitted from the image display apparatus 100. Through the output device 450, the user can recognize whether the user input device 435 is operated or whether the image display apparatus 100 is controlled.

For example, the output device 450 can include an LED module 451 that is turned on in case in which the user input device 435 is operated or a signal is transmitted or received to or from the image display apparatus 100 through the wireless transceiver 425, a vibration module 453 for generating a vibration, an audio output module 455 for outputting an audio, or a display module 457 for outputting an image.

The power supply 460 supplies power to the remote controller 200. When the remote controller 200 is not moved for a certain time, the power supply 460 can stop the supply of power to reduce a power waste. The power supply 460 can resume power supply in case in which a certain key provided in the remote controller 200 is operated.

The memory 470 can store various types of programs, application data, and the like necessary for the control or operation of the remote controller 200. If the remote controller 200 wirelessly transmits and receives a signal to or from the image display apparatus 100 through the RF module 421, the remote controller 200 and the image display apparatus 100 transmit and receive a signal through a certain frequency band. The controller 480 of the remote controller 200 can store information regarding a frequency band or the like for wirelessly transmitting and receiving a signal to or from the image display apparatus 100 paired with the remote controller 200 in the memory 470 and can refer to the stored information.

The controller 480 controls various matters related to the control of the remote controller 200. The controller 480 can be configured to transmit a signal corresponding to a certain key operation of the user input device 435 or a signal corresponding to the motion of the remote controller 200 sensed by the sensor device 440 to the image display apparatus 100 through the wireless transceiver 425.

The user input interface 150 of the image display apparatus 100 includes a wireless transceiver 151 that can wirelessly transmit and receive a signal to and from the remote controller 200 and a coordinate value calculator 415 that can calculate the coordinate value of a pointer corresponding to the operation of the remote controller 200.

The user input interface 150 can wirelessly transmit and receive a signal to and from the remote controller 200 through the RF module 412. In addition, the user input interface 150 can be configured to receive a signal transmitted by the remote controller 200 through the IR module 413 according to a IR communication standard.

The coordinate value calculator 415 can correct a hand shake or an error from a signal corresponding to the operation of the remote controller 200 received through the wireless transceiver 151 and calculate the coordinate value (x, y) of the pointer 205 to be displayed on the display 180.

The transmission signal of the remote controller 200 inputted to the image display apparatus 100 through the user input interface 150 is transmitted to the controller 180 of the image display apparatus 100. The controller 180 can determine the information on the operation of the remote controller 200 and the key operation from the signal transmitted from the remote controller 200, and, correspondingly, control the image display apparatus 100.

For another example, the remote controller 200 can calculate the pointer coordinate value corresponding to the operation and output it to the user input interface 150 of the image display apparatus 100. In this case, the user input interface 150 of the image display apparatus 100 can be configured to transmit information on the received pointer coordinate value to the controller 180 without a separate correction process of handshake or error.

For another example, unlike the figure, the coordinate value calculator 415 can be provided in the signal processing device 170, not in the user input interface 150.

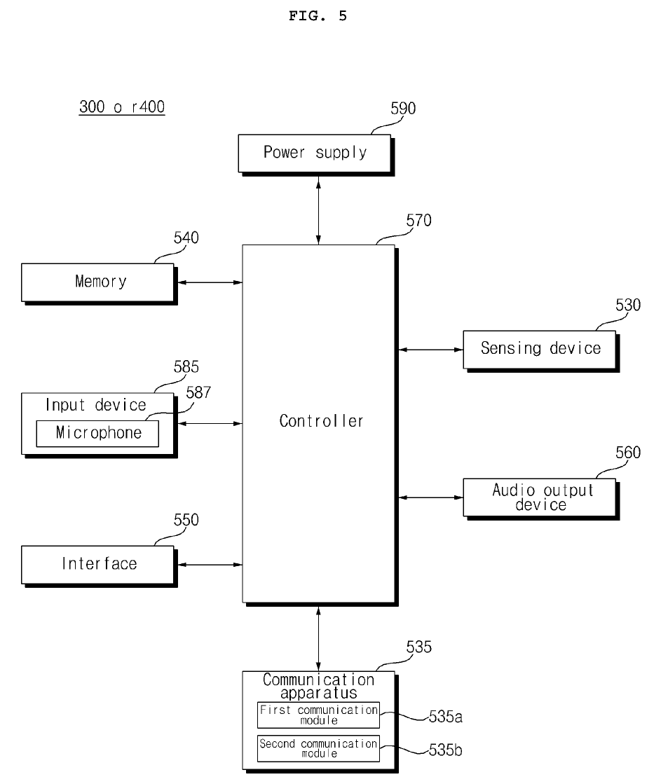

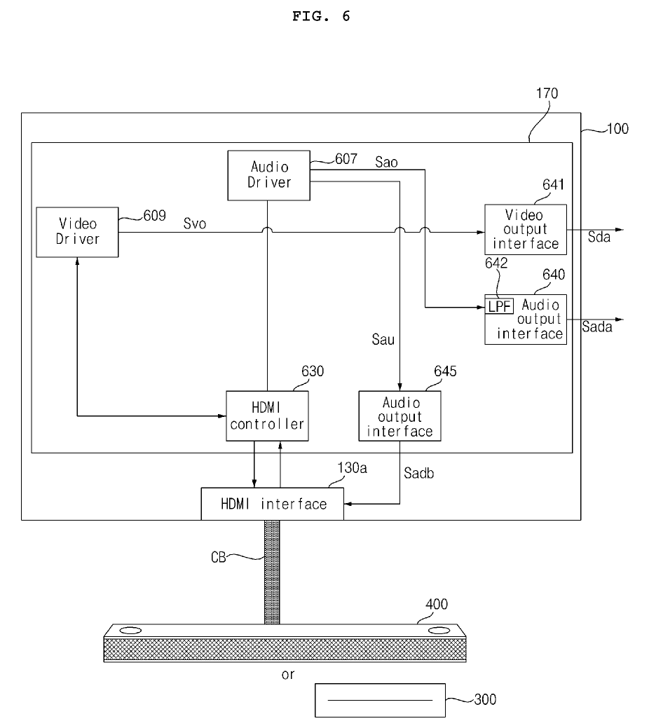

FIG. 5 is an example of an internal block diagram of the sound output device of FIG. 1.

Referring to the figure, the sound output device 400 can include a sensing device 530, a communication apparatus 535, a memory 540, an interface 550, an audio output device 560, a controller 570, an input device 585, and a power supply 590. When these constituting elements are implemented in practical applications, two or more constituting elements can be combined into one constituting element, or one constituting element can be subdivided into two or more constituting elements as needed.

The sensing device 530 can include an inertial sensor (not shown). The inertial sensor can be composed of an acceleration sensor, a gyro sensor, and a gravity sensor. For example, the acceleration sensor, gyro sensor, and gravity sensor can constitute a 6-axis sensor.

The sensing device 530 can output the motion information of the sound output device 400, for example, motion information (acceleration information or angular velocity information) or position information with reference to the x, y, and z axis.

Meanwhile, the sensing device 530 can sense the temperature information, current information, or voltage information of the sound output device 400.

Meanwhile, the communication apparatus 535 can provide an interface for communication with an external device. To this end, the communication apparatus 535 can include a first communication module 535a and a second communication module 535b.

For example, as a wireless communication module, the first communication module 535a within the communication apparatus 535 can provide an interface for wireless data communication such as Bluetooth.

For example, as a wireless communication module, the second communication module 535b within the communication apparatus 535 can provide an interface for wireless data communication such as WiFi or UWB.

The memory 540 can store a program for processing or controlling of the controller 570 within the sound output device 400 and can perform a function for temporarily storing input or output data.

For example, the memory 540 can store output power information or additional offset information of the sound output device 400.

The interface 550 can provide an interface for wired data communication, such as HDMI.

For example, the interface 550 can be configured to transmit output power information or additional offset information of the sound output device 400 to the image display apparatus 100.

The audio output device 560 can output a sound based on the audio signal processed in the controller 570 within the sound output device 400.

The controller 570 can be configured to control the overall operation of the sound output device 400 by controlling the operation of each unit within the sound output device 400.

Meanwhile, the controller 570 can perform signal processing on the audio signal received from the outside.

Meanwhile, the controller 570 can play the audio signal received from the first communication module 535a or second communication module 535b.

Meanwhile, the input device 585 can include a button for initializing the sound output device 400 or motion input.

Meanwhile, the input device 585 can include a microphone 587 for collecting sounds.

Meanwhile, the input device 585 can include a camera (not shown) for photographing an image.

The power supply 590 can supply the power required for the operation of each constituting element under the control of the controller 570.

In particular, the power supply 590 can include a battery (not shown) storing and supplying DC power.

FIG. 6 is an example of an internal block diagram of an image display apparatus due to connection to an external device.

FIG. 6 is an example of an internal block diagram of an image display apparatus due to connection to an external device.

Referring to the figure, an image display apparatus 100 according to an embodiment of the present disclosure includes an interface 130a exchanging data with an external device 300, 400, 600, 1000, or 1100 connected via a wired cable CB and a signal processing device 170.

The interface 130a can be an HDMI interface.

Meanwhile, the signal processing device 170 can be configured to transmit display identification data stored in the memory 140 to the external device 300, 400, 600, 100, or 1100 through the interface 130a.

The external device 300, 400, 600, 100, or 1100 can be configured to transmit image data or audio data based on the received display identification data.

Meanwhile, the interface 130a can be configured to receive image data or audio data from the external device 300, 400, 600, 100, or 1100.

Meanwhile, the signal processing device 170 can include an interface controller 630 for controlling the interface 130a, a video driver 609 for image processing, an audio driver 607 for audio processing, and a video output interface 641 for outputting a video to the display 180, a first audio output interface 640 for outputting an audio signal to the audio output device 185, and a second audio output interface 645 for outputting an audio signal to the external device 300, 400, 600, 100, or 1100.

The video driver 609 and the audio driver 607 can correspond to the image processor 320 and the audio processor 370 of FIG. 3, respectively.

The video driver 609 can use a decoder to decode image data from the external device 300, 400, 600, 100, or 1100 and output decoded image data Svo.

The video output interface 641 can be configured to receive decoded image data Svo from the video driver 609 and output image data Sda to the display 180.

The audio driver 607 can use a decoder to decode audio data from the external device 300, 400, 600, 100, or 1100 and output decoded audio data Sao, Sau.

The first audio output interface 640 can be configured to receive decoded audio data Sao from the audio driver 607 and output audio data Sada to the audio output device 185.

The second audio output interface 645 can be configured to receive decoded audio data Sau from the audio driver 607 and output audio data Sadb to the external device 300, 400, 600, 100, or 1100.

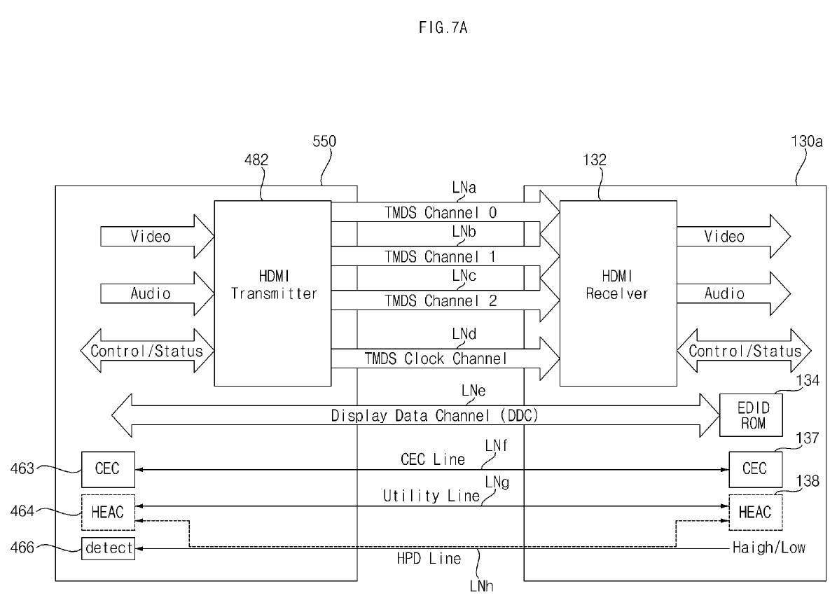

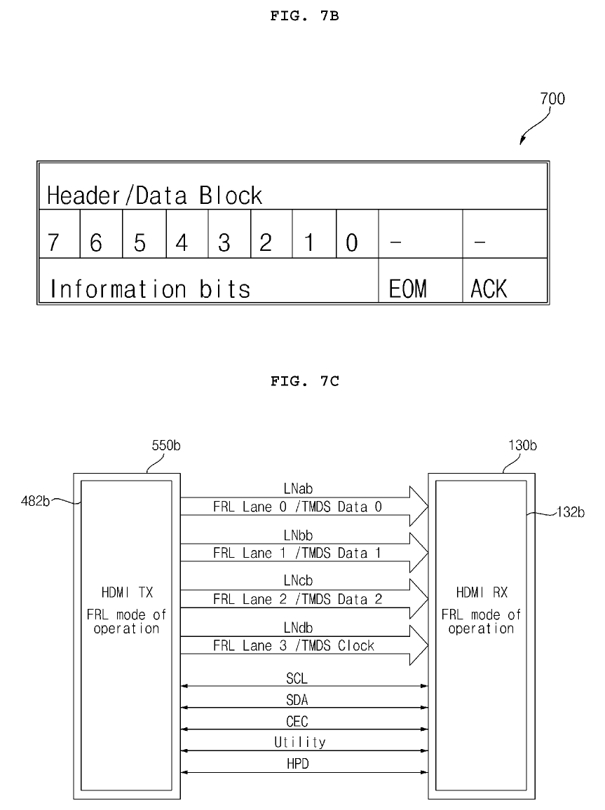

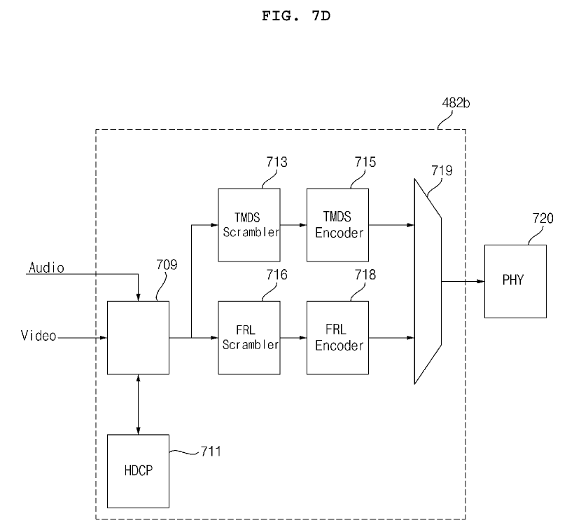

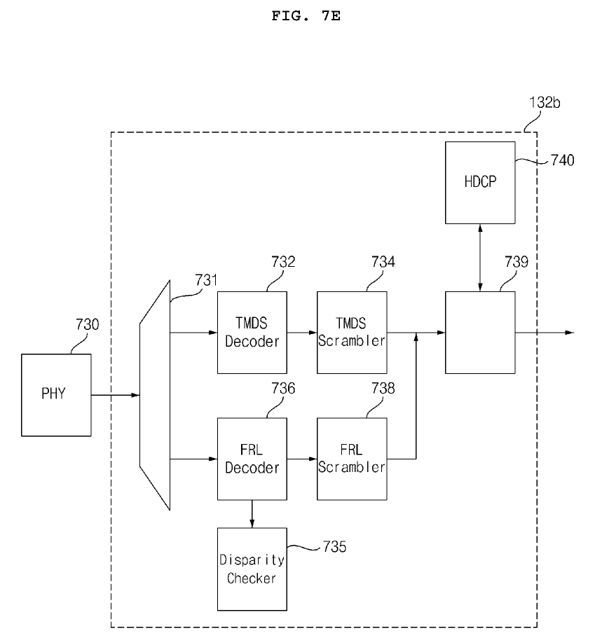

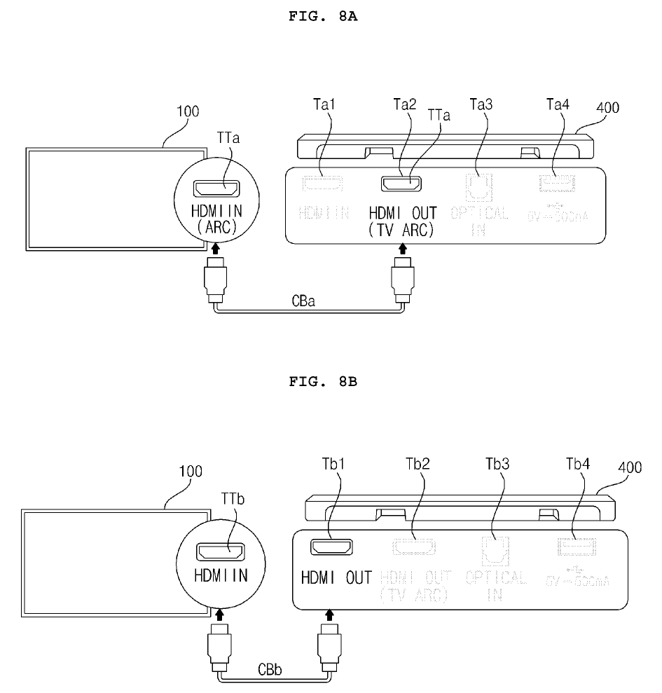

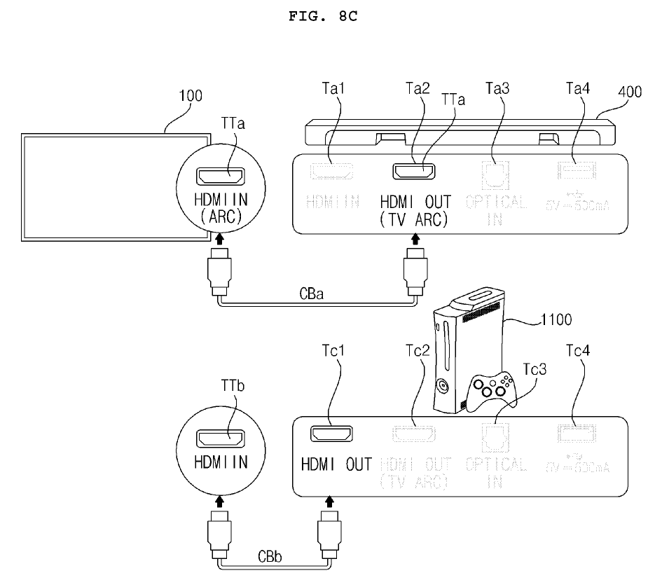

Meanwhile, the interface 130a can be the interface compliant with the HDMI 2.0 specification or the HDMI 2.1 specification. The interface will be described with reference to FIGS. 7A to 7E.

FIGS. 7A to 7E are diagrams referred to in the description of FIG. 6.

First, FIG. 7A illustrates an interface compliant with the HDMI 2.0 specification.

Referring to the figures, the interface 550 within the external device 300, 400, 600, 1000, or 1100 can include an HDMI transmission unit 482 for transmitting video signals.

Meanwhile, the interface 550 within the external device 300, 400, 600, 1000, or 1100 can further include a CEC terminal 463, an HEAC terminal 464, and an HPD terminal 466.

Meanwhile, the interface 130a within the image display apparatus 100 can include an HDMI receiver 132 for receiving a video signal.

Meanwhile, the interface 130a within the image display apparatus 100 can further include an EDID EOM 134, a CEC terminal 137, and an HEAC terminal 138.

Between the HDMI transmitter 482 and the HDMI receiver 132, a plurality of lanes (LNa~LNd), a display data channel line (LNe), a CEC line (LNf), a utility line (LNg), and an HPD line (LNh) can be disposed.

Meanwhile, the plurality of lanes can be transition minimized differential signaling (TMDS) lanes.

For example, among the plurality of lanes (LNa~LNd), a video signal and other data can be transmitted through three lanes, while a clock signal can be transmitted through one lane.

FIG. 7B illustrates the CEC data format of the CEC line in FIG. 7A.

Referring to the figure, the CEC data format 700 can include a plurality of information bits, an EOM, and an ACK.

Next, FIG. 7C illustrates an interface compliant with the HDMI 2.1 specification.

Referring to the figure, the interface 550b within the external device 300, 400, 600, 1000, or 1100 can include an HDMI transmitter 482b for transmitting a video signal.

Meanwhile, the interface 130b within the image display apparatus 100 can include an HDMI receiver 132b for receiving a video signal.

Between the HDMI transmitter 482b and the HDMI receiver 132b, a plurality of lanes (LNab~LNdb), an SCL line, an SDA line, a CEC line, a utility line, and an HPD line can be disposed.

Meanwhile, the plurality of lanes can be fixed rate link (FRL) lanes.

For example, video signals or data signals can be transmitted through the plurality of lanes (LNab~LNdb).

FIG. 7D is an example of an internal block diagram of the HDMI transmitter shown in FIG. 7C.

Referring to the figure, the HDMI transmitter 482b of FIG. 7C can include a first scrambler 716 that scrambles video or audio signals into the first transmission mode, the FRL mode; a first encoder 718 that encodes signals from the first scrambler 716; a second scrambler 713 that scrambles encrypted signals from an encryption unit 709 into the second transmission mode, the TMDS mode; a second encoder 715 that encodes signals from the second scrambler 713; and a signal selector 719 that selects and outputs a signal from the first encoder 718 or a signal from the second encoder 715.

Meanwhile, the signal from the signal selector 719 can be output externally through a physical layer 720 and a port.

Meanwhile, the HDMI transmitter 482b can further include an encryption authentication unit 711, which provides an encryption security key, and an encryption unit 709, which encrypts video or audio signals using the security key.

Specifically, the first scrambler 716 can scramble the encrypted signal from the encryption unit 709 into the first transmission mode, the FRL mode.

Also, the second scrambler 713 can scramble the encrypted signal from the encryption unit 709 into the second transmission mode, the TMDS mode.

Accordingly, video or audio signals can be transmitted either in the first transmission mode, the FRL mode, or in the second transmission mode, the TMDS mode.

FIG. 7E is an example of an internal block diagram of the HDMI receiver 132b shown in FIG. 7C.

Referring to the figure, the HDMI receiver 132b in FIG. 7C can be configured to receive signal externally through a port and a physical layer 730.

The HDMI receiver 132b of FIG. 7C can include a signal selector 731, which selects and outputs either an input signal based on the first transmission mode or an input signal based on the second transmission mode; a first decoder 736, which decodes video or audio signals from the input signal into the first transmission mode, the FRL mode; a third scrambler 738, which scrambles signals from the first decoder 736; a second decoder 732, which decodes video or audio signals from the input signal into the second transmission mode, the TMDS mode; and a fourth scrambler 734, which scrambles signals from the second decoder 732.

Furthermore, the HDMI receiver 132b in FIG. 7c can further include an encryption authentication unit 740, which provides an encryption security key and a decryption unit 730, which performs decryption on signals from the third scrambler 738 or fourth scrambler 734 using the encryption security key.

Meanwhile, the HDMI receiver 132b of FIG. 7C can further include a disparity checker 735, which performs a disparity check based on signals from the first decoder 736.

Accordingly, video or audio signals can be received based on the first transmission mode, the FRL mode, or the second transmission mode, the TMDS mode.

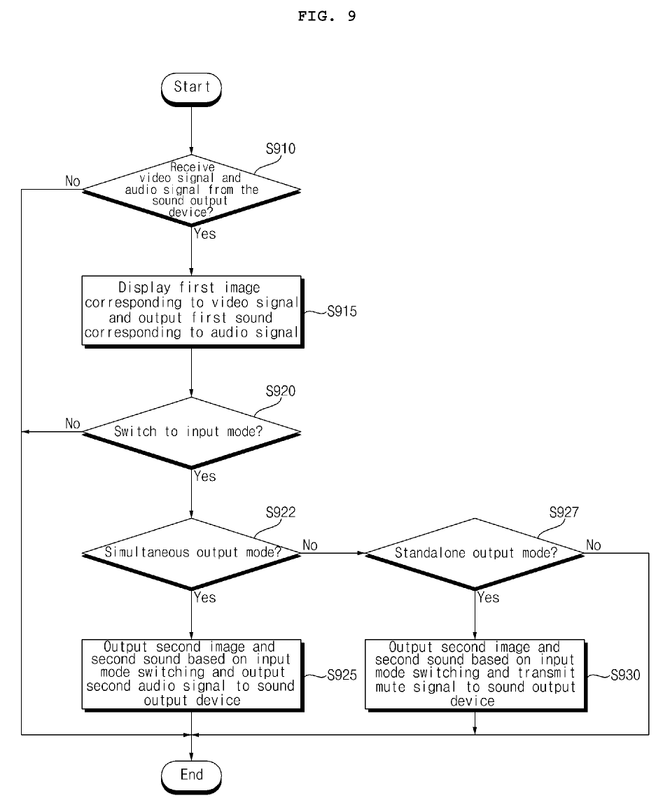

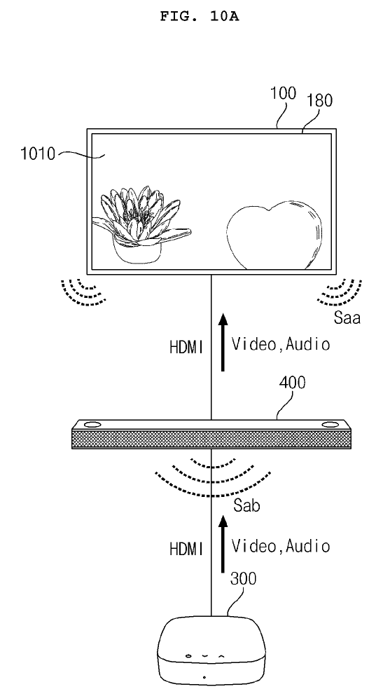

FIGS. 8A to 8C illustrate various interfaces between the image display apparatus and an external device according to an embodiment of the present disclosure.

FIG. 8A illustrates one example of an interface between the image display apparatus 100 and the sound output device 400.

Referring to the figure, the image display apparatus 100 according to an embodiment of the present disclosure includes a display 180, an audio output device 185 configured to output sound, an interface 130 configured to receive signal from an external sound output device 400, and a signal processing device 170.

Meanwhile, the interface 130 can include the HDMI interface 130a.

In particular, the interface 130 includes a first HDMI terminal TTa configured to support an audio return channel.

In the figure, it is assumed that one end of the first cable CBa is connected to the first HDMI terminal TTa, which supports an audio return channel. At this time, the first HDMI terminal TTa can be an HDMI IN terminal.

Meanwhile, the other end of the first cable CBa can be connected to the HDMI terminal Ta2, which supports an audio return channel, among a plurality of terminals Ta1 to Ta4 of the sound output device 400. At this time, the HDMI terminal Ta2 can be an HDMI OUT terminal.

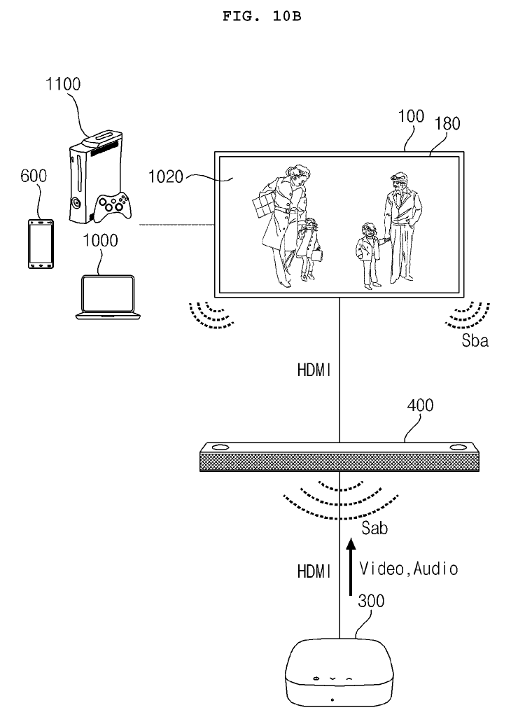

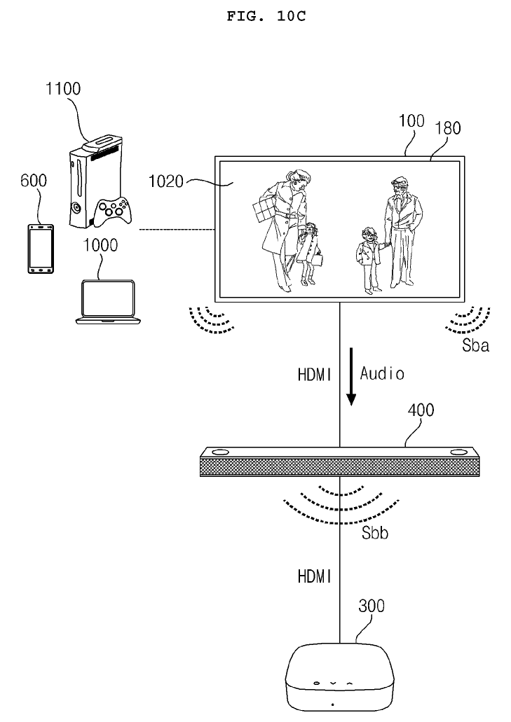

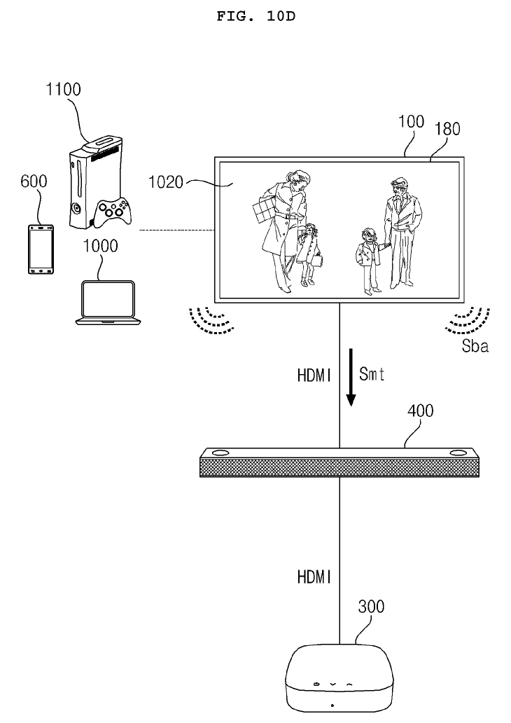

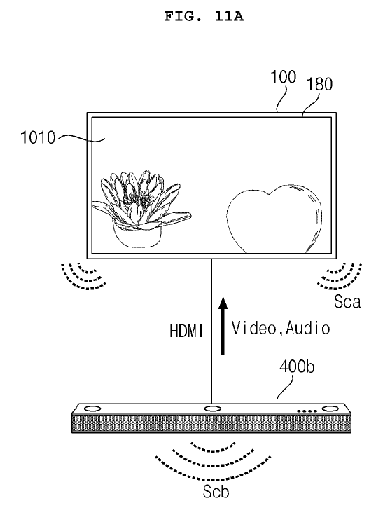

As shown in FIG. 8A, when the image display apparatus 100 and the sound output device 400 are connected through a wired connection, the signal processing device 170 of the image display apparatus 100 controls the display 180 to present the first image (1010 in FIG. 10A) based on the first video signal from the sound output device 400 and, based on the first audio signal from the sound output device 400, controls the audio output device 185 to output the first sound (Saa in FIG. 10A).

In other words, the display 180 of the image display apparatus 100 displays the first image 1010 based on the video signal from the sound output device 400, the audio output device 185 of the image display apparatus 100 outputs the first sound Saa, and the sound output device 400 outputs sound (Sab of FIG. 10) corresponding to the first audio signal.

FIG. 8B illustrates one example of an interface between the image display apparatus 100 and the sound output device 400.

Referring to the figure, the interface 130 of the image display apparatus 100 includes a second HDMI terminal TTb configured to not support an audio return channel.

The figure illustrates an example where one end of the second cable CBb is connected to the second HDMI terminal TTb, which does not support an audio return channel. At this time, the second HDMI terminal TTb can be an HDMI IN terminal.

Meanwhile, the other end of the second cable CBb can be connected to the HDMI terminal Tb1, which does not support an audio return channel, among a plurality of terminals Tb1 to Tb4 of the sound output device 400. At this time, the HDMI terminal Tb1 can be an HDMI OUT terminal.

As shown in FIG. 8A, when the image display apparatus 100 and the sound output device 400 are connected through a wired connection, the signal processing device 170 of the image display apparatus 100 controls the display 180 to present the first image (1010 in FIG. 10A) based on the first video signal from the sound output device 400 and, based on the first audio signal from the sound output device 400, controls the audio output device 185 to output the first sound (Saa in FIG. 10A).

In other words, the display 180 of the image display apparatus 100 displays the first image 1010 based on the video signal from the sound output device 400, the audio output device 185 of the image display apparatus 100 outputs the first sound Saa, and the sound output device 400 outputs sound (Sab of FIG. 10) corresponding to the first audio signal.

FIG. 8C illustrates one example of a connection between the image display apparatus 100, the sound output device 400, and the game console 1100.

Referring to the figure, the interface 130 of the image display apparatus 100 can include a first HDMI terminal TTa configured to support an audio return channel and a second HDMI terminal TTb configured to not support an audio return channel.

The figure illustrates an example where one end of the first cable CBa is connected to the first HDMI terminal TTa, which supports an audio return channel, and one end of the second cable CBb is connected to the second HDMI terminal TTb, which does not support an audio return channel. At this time, both the first HDMI terminal TTa and the second HDMI terminal TTb can be HDMI IN terminals.

Meanwhile, the other end of the first cable CBa can be connected to the HDMI terminal Ta2, which supports an audio return channel, among a plurality of terminals Ta1 to Ta4 of the sound output device 400. At this time, the HDMI terminal Ta2 can be an HDMI OUT terminal.

Meanwhile, the other end of the second cable CBb can be connected to the HDMI terminal Tc1, which does not support an audio return channel, among a plurality of terminals Tc1 to Tc4 of the external device. At this time, the HDMI terminal Tc1 can be an HDMI OUT terminal.

As shown in FIG. 8C, when the image display apparatus 100 and the sound output device 400 are connected via a wired connection, the signal processing device 170 of the image display apparatus 100 controls the display 180 to present the first image 1010 based on the first video signal received from the sound output device 400 and controls the audio output device 185 to output the first sound (Saa of FIG. 10A), based on the first audio signal received from the sound output device 400.

In other words, the display 180 of the image display apparatus 100 can display the first image 1010 based on the video signal received from the sound output device 400, the audio output device 185 of the image display apparatus 100 can output the first sound Saa, and the sound output device 400 can output a sound corresponding to the first audio signal (Sab of FIG. 10).

Meanwhile, if the external input mode is switched, the signal processing device 170 controls the display 180 to present the second image (1020 of FIG. 10C) based on the second video signal received after the external input mode transition; based on the second audio signal received after the external input mode transition, controls the audio output device 185 to output the second sound (Sba of FIG. 10C) or transmits the third audio signal (Audio of FIG. 10C) corresponding to the second audio signal or a mute signal (Smt of FIG. 10D) to the sound output device 400.

Accordingly, when the image display apparatus 100 outputs sound, the sense of discrepancy caused by other sounds from the sound output device 400 can be reduced. Furthermore, when the image display apparatus 100 outputs sound, stable sounds can be produced.

For example, in response to the external input mode being switched, the signal processing device 170 can switch the external input mode from the external input mode from the sound output device 400 to the external input mode from the game console 100.

Accordingly, while outputting the first video and the first sound corresponding to the video signal and audio signal from the sound output device 400, the image display apparatus 100 can output the second video and the second sound corresponding to the second video signal and the second audio signal from the game console 100 based on switching of the external input mode.

At this time, while outputting sound corresponding to the first sound, the sound output device 400 can output the third sound corresponding to the second sound based on the game console 100 or can stop outputting sound based on switching of the external input mode. Accordingly, when the image display apparatus 100 outputs sound, the sense of discrepancy caused by other sounds from the sound output device 400 can be reduced.

FIG. 9 is an example of a method for operating the image display apparatus according to an embodiment of the present disclosure.

Referring to the figure, the signal processing device 170 within the image display apparatus 100 according to one embodiment of the present disclosure determines whether a first video signal and a first audio signal are being input form the sound output device 400 S910; if it is determined that the first video signal and the first audio signal are being input, the signal processing device 170 controls the display 180 to display the first image 1010 based on the first video signal from the sound output device 400 and controls the audio output device 185 to output the first sound Saa based on the first audio signal from the sound output device 400 S915.

If the interface 130 within the image display apparatus 100 according to one embodiment of the present disclosure includes an HDMI interface 130a, whether the sound output device 400 is connected or whether the connected sound output device 400 is powered on can be detected through the HPD line.

The signal processing device 170 within the image display apparatus 100 can switch the external input mode to an input mode based on the sound output device 400 when the sound output device 400 is detected as being connected and powered on.

The signal processing device 170 within the image display apparatus 100 can determine whether the first video signal and the first audio signal are being input from the sound output device 400 through the interface 130; if it is determined that the first video signal and the first audio signal are being input, the signal processing device 170 can process each signal to control the first image corresponding to the first video signal and the first sound corresponding to the first audio signal to be output.

Next, the signal processing device 170 within the image display apparatus 100 can determine whether the external input mode is switched S922; if it is determined that the external input mode is switched, the signal processing device 170 can check whether the simultaneous sound output mode of the image display apparatus 100 and the sound output device 400 is active S922; if the simultaneous sound output mode is active, based on the switched external source, the signal processing device 170 can be configured to control the second image and the second sound to be output and control the second audio signal corresponding to the audio signal from the switched external source to be transmitted S925.

Accordingly, the sound output device 400 can output a sound corresponding to the second image rather than the first image, resulting in stable implementation of the simultaneous sound output mode of the image display apparatus 100 and the sound output device 400.

Meanwhile, if the simultaneous sound output mode is not active in the S922 step, the signal processing device 170 within the image display apparatus 100 can determine whether the standalone sound output mode of the image display apparatus 100 is active S927; if it is determined that the standalone sound output mode is active, based on switching of the external input mode, the signal processing device 170 can be configured to control the second image and the second sound based on the switched external source to be output and control a mute signal to be transmitted to the sound output device 400 S930.

Accordingly, the sound output device 400 can stop outputting the sound corresponding to the first image, resulting in stable implementation of the standalone sound output mode of the image display apparatus 100.

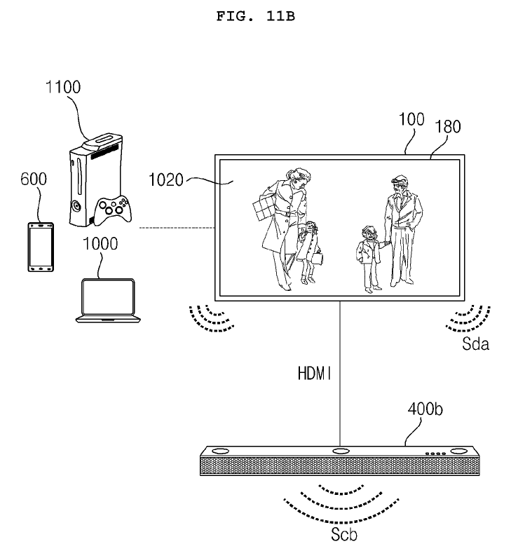

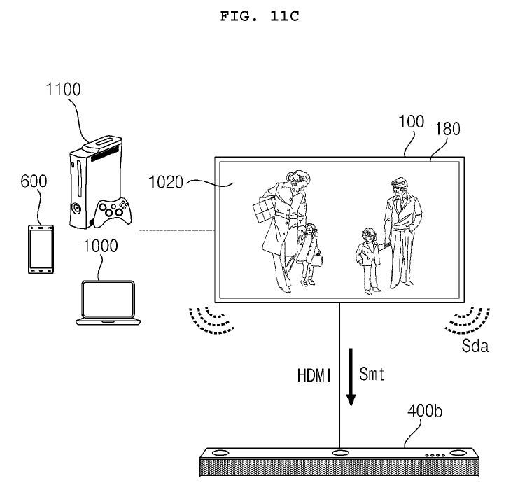

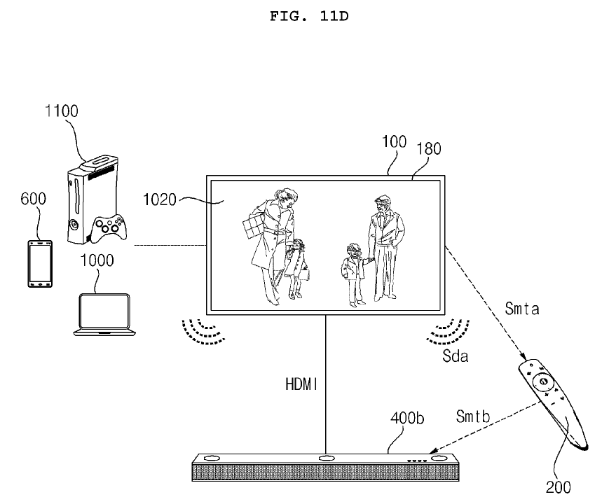

FIGS. 10A to 11D are diagrams referred to in the description of FIG. 9.

FIG. 10A illustrates an example of a wired connection between the image display apparatus and the sound output device.

Referring to the figure, the image display apparatus 100 according to one embodiment of the present disclosure includes a display 180, an audio output device 185 configured to output sound, an interface 130 for receiving signals from an external sound output device 400, and a signal processing device 170 that controls the display 180 to display the first image 1010 based on the first video signal from the sound output device 400 and controls the audio output device 185 to output the first sound Saa based on the first audio signal from the sound output device 400.

Meanwhile, the interface 130 of the image display apparatus 100 can be wired to the sound output device 400 via the HDMI interface 130a.

For example, when the sound output device 400 is powered on, the interface 130 can be configured to receive device information of the sound output device 400 and transmission contents information through the CEC line.

At this time, the device information can include data indicating that a settop device 300 is connected to the sound output device 400.

Meanwhile, the transmission contents information can include information on the video signal and audio signal to be transmitted.

For example, when the settop device 300 is connected to the sound output device 400 and transmit the first video signal and the first audio signal to the sound output device 400, the sound output device 400 can send device information of the sound output device 400 and transmission contents information via the CEC line.

In response to the transmission, the interface 130 of the image display apparatus 100 can be configured to receive the device information of the sound output device 400 and transmission contents information through the CEC line; subsequently, in the first input mode, the interface 130 can be configured to receive the first video signal and the first audio signal from the sound output device 400 through a plurality of Transition Minimized Differential Signaling (TMDS) lanes or a plurality of Fixed Rate Link (FRL) lanes.

Meanwhile, when the simultaneous sound output mode with the sound output device 400 is active, in the first input mode, the signal processing device 170 can be configured to control the display 180 to present the first image 1010 based on the first video signal from the sound output device 400 and control the audio output device 185 to output the first sound Saa based on the first audio signal from the sound output device 400.

Meanwhile, the sound output device 400 can output sound Sab corresponding to the first audio signal. Accordingly, stable sound can be output in the simultaneous sound output mode.

Meanwhile, when the sound output device 400 operates in the standalone sound output mode, in the input mode, the signal processing device 170 can be configured to control the display 180 to display the first image 1010 based on the first video signal from the sound output device 400 and control the audio output device 185 not to output sound related to the first audio signal from the sound output device 400.

FIG. 10B illustrates an example where at least one external device is connected via a wired connection while the sound output device is wired to the image display apparatus according to the present disclosure.

Referring to the figure, the external device can include a game console 1100, a laptop computer 1000, or a mobile terminal 600.

For example, when an external device, such as a game console 1100, is wired to the interface 130 through a separate HDMI terminal and the external input mode switches from the sound output device to the game console, the interface 130 can be configured to receive the second video signal and the second audio signal from the game console 1100 based on the switching of the external input mode.

Accordingly, the display 180 can present the second image 1020 corresponding to the second video signal, and the audio output device 185 can output the second sound Sba corresponding to the second audio signal.

However, the sound output device 400 can output sound Sab corresponding to the first audio signal received from the settop device 300. As a result, in the simultaneous sound output mode, the image display apparatus 100 and the sound output device 400 can output sounds from different sources, generating a sense of discrepancy in sound perception.

To reduce the sense of discrepancy, the present disclosure proposes that in response to the external input mode being switched, an audio signal corresponding to the switching of the external input mode is transmitted to the sound output device 400 or a mute signal is transmitted to stop sound output. The operation above will be described in more detail with reference to FIG. 10C.

FIG. 10C illustrates an example of at least one external device being wired while the sound output device is connected to the image display apparatus according to an embodiment of the present disclosure.

Referring to the figure, the external device can include a game console 1100, a laptop computer 1000, or a mobile terminal 600.

For example, when an external device, such as a game console 1100, is wired to the interface 130 through a separate HDMI terminal and the external input mode switches from the sound output device to the game console, the interface 130 can be configured to receive the second video signal and the second audio signal from the game console 1100 based on the switching of the external input mode.

In response to the external input mode being switched, the signal processing device 170 can be configured to control the display 180 to present the second image 1020 based on the second video signal received based on the switching of the external input mode, control the audio output device 185 to output the second sound Sba corresponding to the second audio signal received based on the switching of the external input mode, and control the third audio signal corresponding to the second audio signal or a mute signal Smt to be transmitted to the sound output device 400. Accordingly, when the image display apparatus 100 outputs sound, the sense of discrepancy caused by other sounds from the sound output device 400 can be reduced.

Meanwhile, if the external input mode is switched to the simultaneous sound output mode with the sound output device 400, as shown in the figure, the signal processing device 170 can be configured to control the third audio signal AUDIO corresponding to the second audio signal to be transmitted to the sound output device 400.

In response to the operation above, the sound output device 400 can output a sound Sbb corresponding to the third audio signal AUDIO input from the image display apparatus 100 rather than the sound Sab corresponding to the first audio signal input from the settop device 300.

Accordingly, since the image display apparatus 100 and the sound output device 400 output sounds from the same source in the simultaneous sound output mode, the sense of discrepancy caused by other sounds from the sound output device 400 can be reduced when the image display apparatus outputs sound.

Meanwhile, the interface 130 can include a first HDMI terminal TTa and a second HDMI terminal TTb.

Meanwhile, in the first input mode, the interface 130 can be configured to receive the first video signal and the first audio signal from the sound output device 400 through the first HDMI terminal TTa; in the second input mode with the external input mode switched, the second HDMI terminal TTb can be configured to receive the second video signal and the second audio signal from a connected external device.

Meanwhile, the interface 130 can include the first HDMI terminal TTa, which supports an audio return channel, and the second HDMI terminal TTb, which does not support the audio return channel.

Meanwhile, in the second input mode, if the simultaneous sound output mode with the sound output device 400 is active and it is possible to transmit signals to the sound output device 400 through the audio return channel, the first HDMI terminal TTa can be configured to transmit the third audio signal corresponding to the second audio signal to the sound output device 400. Accordingly, when the image display apparatus outputs sound, the sense of discrepancy caused by other sounds from the sound output device can be reduced.

Meanwhile, in the second input mode, if the simultaneous sound output mode is active, the signal processing device 170 can be configured to control the image display apparatus 100, the sound output device 400, and an external device such as the game console 1100 to output sounds separately.

Meanwhile, in the first simultaneous sound output mode within the second input mode, the signal processing device 170 can be configured to control the image display apparatus 100 and an external device, such as the game console 1100, to output sound separately.

Meanwhile, in the second simultaneous sound output mode within the second input mode, the signal processor 170 can be configured to control the image display apparatus 100 and the sound output device 400 to output sound separately. As a result, simultaneous sound output can be achieved in a stable manner through a combination of various devices.

FIG. 10D illustrates another example of at least one external device being wired while the sound output device is connected to the image display apparatus according to an embodiment of the present disclosure.

Referring to the figure, the external device can include a game console 1100, a laptop computer 1000, or a mobile terminal 600.

For example, when an external device, such as a game console 1100, is wired to the interface 130 through a separate HDMI terminal and the external input mode switches from the sound output device to the game console, the interface 130 can be configured to receive the second video signal and the second audio signal from the game console 1100 based on the switching of the external input mode.

Meanwhile, in response to the external input mode being switched, the signal processing device 170 can be configured to control the display 180 to present the second image 1020 based on the second video signal received based on the switching of the external input mode and control the audio output device 185 to output the second sound Sba based on the second audio signal received based on the switching of the external input mode.

Meanwhile, in response to the external input mode being switched, the signal processing device 170 can be configured to transmit the mute signal Smt to the sound output device 400 if the image display apparatus 100 is in the standalone sound output mode or in response to transmission of an audio return channel signal to the sound output device 400 being not possible.

In response to the operation above, the sound output device 400 can stop outputting sound Sab corresponding to the first audio signal. Accordingly, when the image display apparatus 100 outputs sound, the sense of discrepancy caused by other sounds from the sound output device 400 can be reduced.

Referring to FIGS. 10C and 10D, the interface 130 of the image display apparatus 100 can determine whether the HDMI specification of the sound output device 400 is version 2.0 or lower, or version 2.1 or higher.

Meanwhile, if the HDMI specification for the sound output device 400 is version 2.0 or lower, the interface 130 of the image display apparatus 100 is wired to the sound output device 400 through the HDMI interface 130a; in the first input mode, the interface 130 can be configured to receive the first video signal and the first audio signal from the sound output device 400 through a plurality of Transition Minimized Differential Signaling (TMDS) lanes.

Next, in the second input mode with the external input mode switched, the interface 130 of the image display apparatus 100 can be configured to transmit a third audio signal corresponding to the second audio signal to the sound output device 400 through a subset of a plurality of TMDS lanes or a utility line or can be configured to transmit a mute signal Smt. Accordingly, when the image display apparatus outputs sound, the sense of discrepancy caused by other sounds from the sound output device can be reduced.

Meanwhile, if the HDMI specification for the sound output device 400 is version 2.1 or higher, the interface 130 of the image display apparatus 100 can be wired to the sound output device 400 through the HDMI interface 130a and can be configured to receive the first video signal and the first audio signal from the sound output device 400 through a plurality of fixed rate link (FRL) lanes in the first input mode.

Next, in the second input mode with the external input mode switched, the interface 130 of the image display apparatus 100 can be configured to transmit a third audio signal corresponding to the second audio signal to the sound output device 400 through a subset of a plurality of FRL lanes or a utility line or can be configured to transmit a mute signal Smt. Accordingly, when the image display apparatus outputs sound, the sense of discrepancy caused by other sounds from the sound output device can be reduced.

FIGS. 11A to 11D correspond to FIGS. 10A to 10D, except that a settop device is included within the sound output device.

FIG. 11A illustrates a case where a sound output device is wired to the image display apparatus.

Referring to the figure, the interface 130 of the image display apparatus 100 can be configured to receive the device information of the sound output device 400b and transmission contents information through the CEC line; subsequently, in the first input mode, the interface 130 can be configured to receive the first video signal and the first audio signal from the sound output device 400b through a plurality of Transition Minimized Differential Signaling (TMDS) lanes or a plurality of Fixed Rate Link (FRL) lanes.

Meanwhile, when the simultaneous sound output mode with the sound output device 400b is active, in the first input mode, the signal processing device 170 can be configured to control the display 180 to present the first image 1010 based on the first video signal from the sound output device 400b and control the audio output device 185 to output the first sound Saa based on the first audio signal from the sound output device 400b.

Meanwhile, the sound output device 400b can output sound Sab corresponding to the first audio signal. Accordingly, stable sound can be output in the simultaneous sound output mode.

FIG. 11B illustrates an example where at least one external device is connected via a wired connection while the sound output device is wired to the image display apparatus according to the present disclosure.

Referring to the figure, when an external device, such as a game console 1100, is wired to the interface 130 through a separate HDMI terminal and the external input mode switches from the sound output device to the game console, the interface 130 can be configured to receive the second video signal and the second audio signal from the game console 1100 based on the switching of the external input mode.

Accordingly, the display 180 can present the second image 1020 corresponding to the second video signal, and the audio output device 185 can output the second sound Sba corresponding to the second audio signal.

However, the sound output device 400b can output sound Sab corresponding to the first audio signal received from the settop device 300. In other words, since the image display apparatus 100 and the sound output device 400 output sounds from different sources, a sense of discrepancy is generated in sound perception.

FIG. 11C illustrates an example of at least one external device being wired while the sound output device is connected to the image display apparatus according to an embodiment of the present disclosure.

Referring to the figure, when an external device, such as a game console 1100, is wired to the interface 130 through a separate HDMI terminal and the external input mode switches from the sound output device to the game console, the interface 130 can be configured to receive the second video signal and the second audio signal from the game console 1100 based on the switching of the external input mode.

In response to the external input mode being switched, the signal processing device 170 can be configured to control the display 180 to present the second image 1020 based on the received second video signal and control the audio output device 185 to output the second sound Sba based on the received second audio signal.

Meanwhile, if the external input mode is switched, the signal processing device 170 controls a mute signal Smt to be transmitted to the sound output device 400b.

For example, if the interface 130 is capable of transmitting a signal to the sound output device 400b through the audio return channel, the interface 130 can be configured to transmit a mute signal Smt to the sound output device 400b through a subset of the plurality of transition minimized differential signaling (TMDS) lanes or a utility line.

In another example, if the interface 130 is capable of transmitting a signal to the sound output device 400b through the audio return channel, the interface 130 can be configured to transmit a mute signal Smt to the sound output device 400b through a subset of the plurality of fixed rate link (FRL) lanes or a utility line.

In yet another example, in response to transmission of an audio return channel signal to the sound output device 400b being not possible, the interface 130 can be configured to control the mute signal Smt to be transmitted to the sound output device 400b.

FIG. 11C illustrates another example of at least one external device being wired while the sound output device is connected to the image display apparatus according to an embodiment of the present disclosure.

Referring to the figure, in response to the external input mode being switched, the signal processing device 170 can be configured to control the display 180 to present the second image 1020 based on the second video signal received based on the switching of the external input mode and control the audio output device 185 to output the second sound Sba based on the second audio signal received based on the switching of the external input mode.

Meanwhile, in response to the external input mode being switched, the signal processing device 170 can be configured to transmit the mute signal Smt to the sound output device 400b if the image display apparatus 100 is in the standalone sound output mode or in response to transmission of an audio return channel signal to the sound output device 400b being not possible.

To this end, the signal processing device 170 can be configured to transmit a first mute signal Smta to the remote-control device 200, which is paired via an RF signal or Bluetooth.

Meanwhile, the remote control device 200 can be configured to receive the first mute signal Smta based on the RF signal and transmit a second mute signal Smtb to the sound output device 400b based on an IR signal.

In response to the operation above, the sound output device 400b can be configured to receive a second mute signal Smtb based on the IR signal and stop outputting the sound Sab corresponding to the first audio signal. Accordingly, when the image display apparatus 100 outputs sound, the sense of discrepancy caused by other sounds from the sound output device 400b can be reduced.

FIG. 12 is an example of a method for operating the image display apparatus according to another embodiment of the present disclosure.

Referring to the figure, the signal processing device 170 within the image display apparatus 100 according to another embodiment of the present disclosure determines whether a first video signal and a first audio signal are being input form the settop device 300b S1210; if it is determined that the first video signal and the first audio signal are being input, the signal processing device 170 controls the display 180 to display the first image 1010 based on the first video signal from the settop device 300b and controls the audio output device 185 to output the first sound Sfa based on the first audio signal from the settop device 300b S1215.

If the interface 130 within the image display apparatus 100 according to another embodiment of the present disclosure includes an HDMI interface 130a, whether the settop device 300b is connected or whether the connected settop device 300b is powered on can be detected through the HPD line.

The signal processing device 170 within the image display apparatus 100 can switch the external input mode to an input mode based on the settop device 300b when the settop device 300b is detected as being connected and powered on.

The signal processing device 170 within the image display apparatus 100 can determine whether the first video signal and the first audio signal are being input from the settop device 300b through the interface 130; if it is determined that the first video signal and the first audio signal are being input, the signal processing device 170 can process each signal to control the first image corresponding to the first video signal and the first sound Sfa corresponding to the first audio signal to be output.

Next, the signal processing device 170 within the image display apparatus 100 can determine whether the external input mode is switched S1222; if it is determined that the external input mode is switched, the signal processing device 170 can check whether the simultaneous sound output mode of the image display apparatus 100 and the settop device 300b is active S1220; if the simultaneous sound output mode is active, based on the switched external source, the signal processing device 170 can be configured to control the second image and the second sound to be output and control the mute signal Smt to be transmitted to the settop device 300b or the sound output device 400 connected to the settop device 300b S1230.

Accordingly, the sense of discrepancy caused by other sounds from the settop device 300b can be reduced when the image display apparatus outputs sound. In particular, when the image display apparatus 100 outputs sound independently, stable sound output can be ensured.

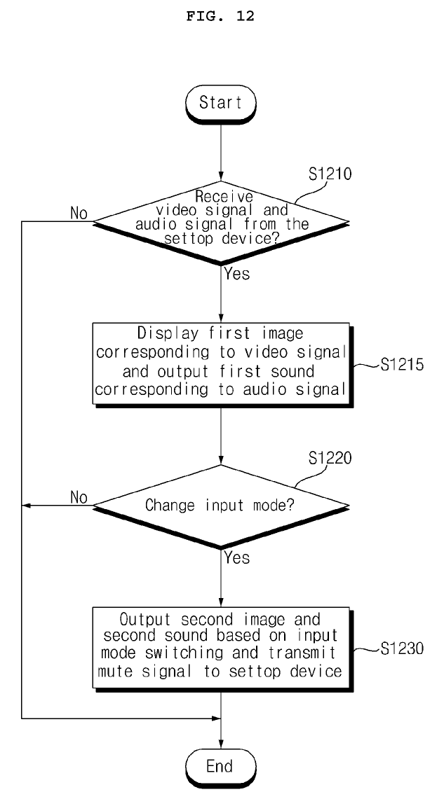

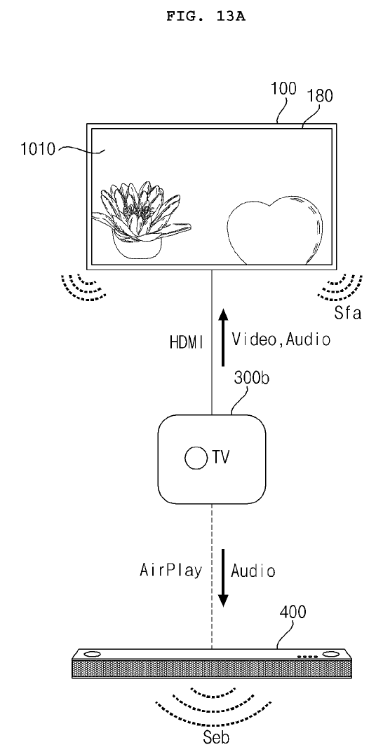

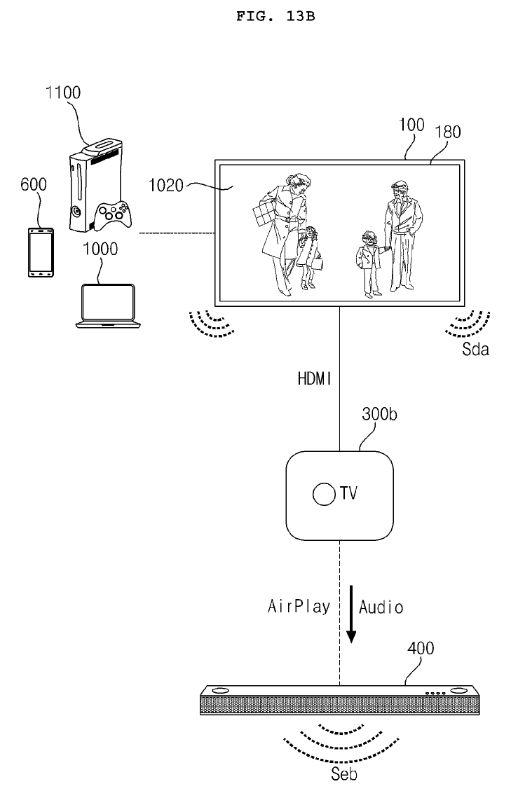

FIGS. 13A to 13C are diagrams referred to in the description of FIG. 12.

FIG. 13A illustrates a case in which a settop device is wired to the image display apparatus.

Referring to the figure, the image display apparatus 100 according to another embodiment of the present disclosure includes a display 180, an audio output device 185 configured to output sound, an interface 130 for receiving signals from an external settop device 300b, and a signal processing device 170 that controls the display 180 to display the first image 1010 based on the first video signal from the settop device 300b and controls the audio output device 185 to output the first sound Sfa based on the first audio signal from the settop device 300b.

Meanwhile, the settop device 300b can be connected separately to the sound output device 400 and transmit an audio signal to the sound output device 400.

Meanwhile, the interface 130 of the image display apparatus 100 can be wired to the settop device 300b via the HDMI interface 130a.

For example, when the settop device 300b is powered on, the interface 130 can be configured to receive device information of the settop device 300b and transmission contents information through the CEC line.

At this time, the device information can include data indicating that a settop device 300b is connected to the sound output device 400.

Meanwhile, the transmission contents information can include information on the video signal and audio signal to be transmitted.

For example, when the settop device 300 is connected to the settop device 300b and transmit the first video signal and the first audio signal to the settop device 300b, the settop device 300b can send device information of the settop device 300b and transmission contents information via the CEC line.

In response to the transmission, the interface 130 of the image display apparatus 100 can be configured to receive the device information of the settop device 300b and transmission contents information through the CEC line; subsequently, in the first input mode, the interface 130 can be configured to receive the first video signal and the first audio signal from the settop device 300b through a plurality of Transition Minimized Differential Signaling (TMDS) lanes or a plurality of Fixed Rate Link (FRL) lanes.

Meanwhile, in the first input mode, the signal processing device 170 can be configured to control the display 180 to present the first image 1010 based on the first video signal from the settop device 300b and control the audio output device 185 to output the first sound Sfa based on the first audio signal from the settop device 300b.

Meanwhile, the sound output device 400 connected to the settop device 300b can output sound Seb corresponding to the first audio signal. Accordingly, stable sound can be output in the simultaneous sound output mode.

FIG. 13B illustrates an example where at least one external device is connected via a wired connection while the settop device is wired to the image display apparatus according to the present disclosure.

Referring to the figure, when an external device, such as a game console 1100, is wired to the interface 130 through a separate HDMI terminal and the external input mode switches from the sound output device to the game console, the interface 130 can be configured to receive the second video signal and the second audio signal from the game console 1100 based on the switching of the external input mode.

Accordingly, the display 180 can present the second image 1020 corresponding to the second video signal, and the audio output device 185 can output the second sound Sda corresponding to the second audio signal.

However, the sound output device 400 wired to the settop device 300b can output sound Seb corresponding to the first audio signal received from the settop device 300. As a result, in the simultaneous sound output mode, the image display apparatus 100 and the settop device 300b can output sounds from different sources, generating a sense of discrepancy in sound perception.

FIG. 13C illustrates an example of at least one external device being wired while the settop device is connected to the image display apparatus according to an embodiment of the present disclosure.

Referring to the figure, when an external device, such as a game console 1100, is wired to the interface 130 through a separate HDMI terminal and the external input mode switches from the sound output device to the game console, the interface 130 can be configured to receive the second video signal and the second audio signal from the game console 1100 based on the switching of the external input mode.

Meanwhile, in response to the external input mode being switched, the signal processing device 170 can be configured to control the display 180 to present the second image 1020 based on the second video signal received based on the switching of the external input mode, control the audio output device 185 to output the second sound Sda corresponding to the second audio signal received based on the switching of the external input mode, and control the mute signal Smt to be transmitted to the settop device 200b or the sound output device 400 connected to the settop device 300b.

Accordingly, when the image display apparatus 100 outputs sound, the sense of discrepancy caused by other sounds from the settop device 400 can be reduced. In particular, when the image display apparatus 100 outputs sound independently, stable sound output can be ensured.

Meanwhile, the interface 130 can include a first HDMI terminal TTa and a second HDMI terminal TTb.

Meanwhile, in the first input mode, the interface 130 can be configured to receive the first video signal and the first audio signal from the settop device 300b through the first HDMI terminal TTa; in the second input mode with the external input mode switched, the second HDMI terminal TTb can be configured to receive the second video signal and the second audio signal from a connected external device.

Meanwhile, the interface 130 can include the first HDMI terminal TTa, which supports an audio return channel, and the second HDMI terminal TTb, which does not support the audio return channel.

Meanwhile, in the second input mode, if the simultaneous sound output mode with the settop device 300b is active and it is possible to transmit signals to the settop device 300b through the audio return channel, the first HDMI terminal TTa can be configured to transmit the mute signal Smt to the settop device 300b.

Accordingly, the sound output device 400 wired to the settop device 300b can stop outputting sound Seb corresponding to the first audio signal. As a result, when the image display apparatus 100 outputs sound, the sense of discrepancy caused by other sounds from the settop device 300b can be reduced.

FIG. 13D illustrates another example of at least one external device being wired while the settop device is connected to the image display apparatus according to an embodiment of the present disclosure.

Referring to the figure, when an external device, such as a game console 1100, is wired to the interface 130 through a separate HDMI terminal and the external input mode switches from the sound output device to the game console, the interface 130 can be configured to receive the second video signal and the second audio signal from the game console 1100 based on the switching of the external input mode.

Meanwhile, in response to the external input mode being switched, the signal processing device 170 can be configured to control the display 180 to present the second image 1020 based on the second video signal received based on the switching of the external input mode and control the audio output device 185 to output the second sound Sba based on the second audio signal received based on the switching of the external input mode.

Meanwhile, in response to the external input mode being switched, the signal processing device 170 can be configured to transmit the mute signal Smt to the sound output device 400 connected to the settop device 300b if the image display apparatus 100 is in the standalone sound output mode or in response to transmission of an audio return channel signal to the settop device 300b being not possible.

Meanwhile, the interface 130 can include the first HDMI terminal TTa, which supports an audio return channel, and the second HDMI terminal TTb, which does not support the audio return channel.

Meanwhile, in response to an external device being connected to the first HDMI terminal TTa and the settop device 300b is connected to the second HDMI terminal TTb, in the first input mode, the first HDMI terminal TTa can be configured to receive the first video signal and the first audio signal from the settop device 300b through the second HDMI terminal TTb; and in the second input mode to which the external input mode has been switched, the first HDMI terminal TTa can be configured to receive the second image signal and the second audio signal from a connected external device, while the second HDMI terminal TTb cannot transmit the third audio signal or the mute signal Smt to the settop device 300b.

Meanwhile, in response to the external input mode being switched, the signal processing device 170 can be configured to transmit the mute signal Smt to the sound output device 400 if the image display apparatus 100 is in the standalone sound output mode or in response to transmission of an audio return channel signal to the settop device 300b being not possible.

To this end, the signal processing device 170 can be configured to transmit the first mute signal Smta to the remote-control device 200, which is paired via an RF signal or Bluetooth.

Meanwhile, the remote-control device 200 can be configured to receive the first mute signal Smta based on the RF signal and transmit a second mute signal Smtb to the sound output device 400 based on an IR signal.

In response to the operation above, the sound output device 400 may be configured to receive the second mute signal Smtb based on the IR signal and stop outputting the sound Seb corresponding to the first audio signal. Accordingly, when the image display apparatus 100 outputs sound, the sense of discrepancy caused by other sounds from the sound output device 400b can be reduced.

Referring to FIGS. 13C and 13D, the interface 130 of the image display apparatus 100 can determine whether the HDMI specification of the settop device 300b is version 2.0 or lower, or version 2.1 or higher.

Meanwhile, if the HDMI specification for the settop device 300b is version 2.0 or lower, the interface 130 of the image display apparatus 100 is wired to the settop device 300b through the HDMI interface 130a; in the first input mode, the interface 130 can be configured to receive the first video signal and the first audio signal from the settop device 300b through a plurality of Transition Minimized Differential Signaling (TMDS) lanes.

Next, in the second input mode with the external input mode switched, the interface 130 of the image display apparatus 100 can be configured to transmit a mute signal Smt to the settop device 300b through a subset of a plurality of TMDS lanes or a utility line. Accordingly, when the image display apparatus outputs sound, the sense of discrepancy caused by other sounds from the settop device 300b can be reduced.

Meanwhile, if the HDMI specification for the settop device 300b is version 2.1 or higher, the interface 130 of the image display apparatus 100 can be wired to the settop device 300b through the HDMI interface 130a and can be configured to receive the first video signal and the first audio signal from the settop device 300b through a plurality of fixed rate link (FRL) lanes in the first input mode.

Next, in the second input mode with the external input mode switched, the interface 130 of the image display apparatus 100 can be configured to transmit a mute signal Smt to the settop device 300b through a subset of the plurality of FRL lanes or a utility line.

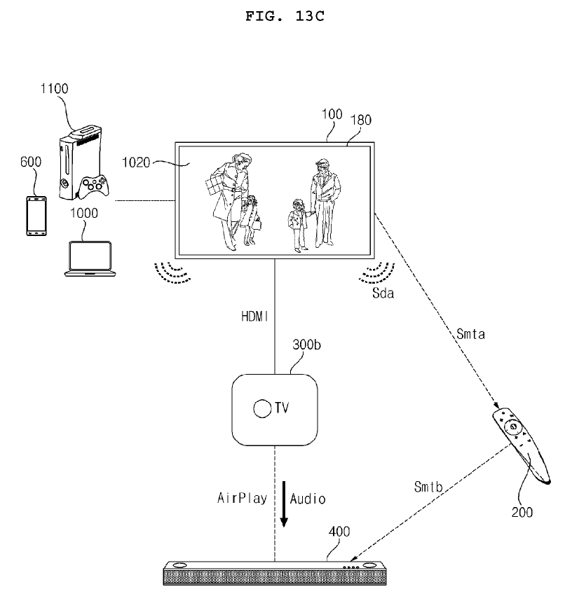

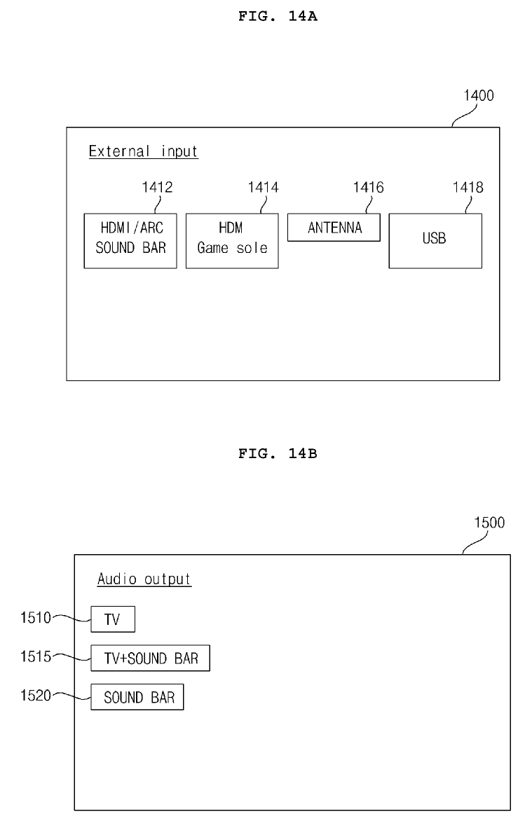

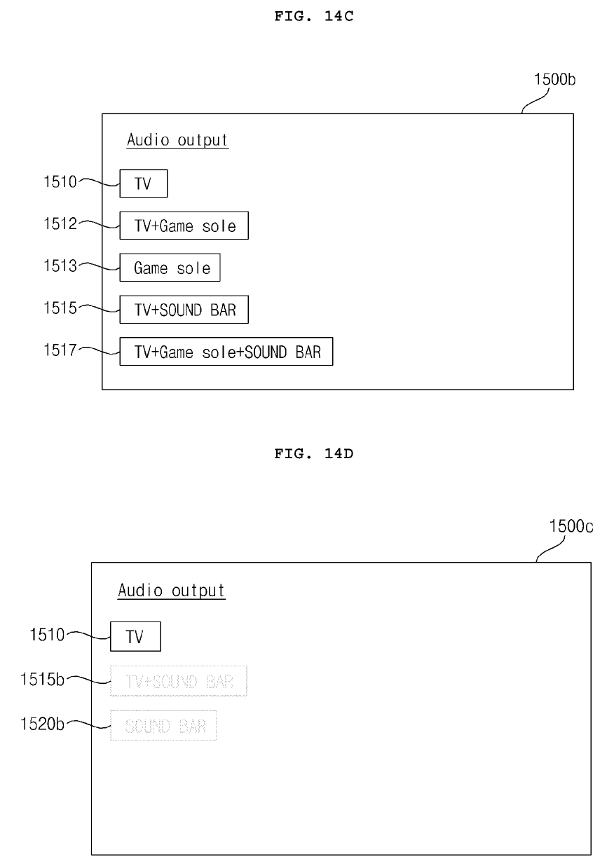

FIGS. 14A to 14D are diagrams referred to in the description of FIGS. 9 or 12.

FIG. 14A illustrates one example of an external input screen.

Referring to the figure, the external input screen 1400 can display items such as a sound output device item 1412 connected to the HDMI/ARC terminal TTa, a game console item 1414 connected to the HDMI terminal TTb, an antenna item 1416, and a USB item 1418.

The signal processing device 170 can be configured to control the display of the external input screen 1400 based on input signals.

FIGS. 10A to 11D illustrate a case in which the external input mode switches from the sound output device item 1412 to the game console item 1414; however, the present disclosure is not limited to the specific case, and the external input mode can also switch from the sound output device item 1412 to the antenna item 1416 or the USB item 1418.

For example, in response to the external input mode being switched to the antenna item 1416, broadcast video and broadcast sound corresponding to broadcast signals can be output respectively.

In another example, in response to the external input mode being switched to the USB item 1418, video and sound corresponding to the video signal and audio signal from a mobile terminal 600 or a storage device (not shown) can be output.

FIG. 14B illustrates an example of an audio output mode.

Referring to the figure, the signal processing device 170 can be configured to control the display of the audio output mode screen 1500 based on input signals.

The signal processing device 170 can be configured to control the display of the audio output mode screen 1500 when the sound output device 400 is connected via a wired connection.

The audio output mode screen 1500 can include a standalone sound output item 1510 of the image display apparatus, a simultaneous sound output item 1515 of the image display apparatus and the sound output device, and a standalone sound output item 1520 of the sound output device.

The signal processing device 170 can be configured to control the sound output according to a selected item among the plurality of items.

FIG. 14C illustrates another example of the audio output mode.

Referring to the figure, the signal processing device 170 can be configured to control the display of the audio output mode screen 1500b based on input signals.

The signal processing device 170 can be configured to control the display of the audio output mode screen 1500b when the sound output device 400 is connected via a wired connection and a game console 1100 is subsequently connected via a wired connection.

The audio output mode screen 1500b can include a standalone sound output item 1510 of the image display apparatus, a simultaneous sound output item 1512 of the image display apparatus and the game console, a standalone sound output item 1513 of the game console, a simultaneous sound output item 1515 of the image display apparatus and the sound output device, and a simultaneous sound output item 1517 of the image display apparatus, the game console, and the sound output device.

The signal processing device 170 can be configured to control the sound output according to a selected item among the plurality of items.

FIG. 14D illustrates yet another example of the audio output mode.

Referring to the figure, the signal processing device 170 can be configured to control the display of the audio output mode screen 1500c based on input signals.

The signal processing device 170 can be configured to control the display of the audio output mode screen 1500c when the sound output device 400, previously connected via a wired connection, is disconnected or its power is turned off.

In particular, the signal processing device 170 can deactivate the simultaneous sound output item 1515b of the image display apparatus and the sound output device; and the standalone sound output item 1520b of the sound output device, which are related to the sound output device among the plurality of items within the audio output mode screen 1500c. As a result, the audio output mode can be intuitively recognized.

As described above, an image display apparatus according to an embodiment of the present disclosure comprises a display, an audio output device configured to output sound, an interface configured to receive signal from an external sound output device, and a signal processing device configured to display a first image on the display based on a first video signal received from the sound output device and output a first sound to the audio output device based on a first audio signal received from the sound output device, wherein in response to the external input mode being switched, the signal processing device is configured to display a second image on the display based on a second image signal received based on the transition to the external input mode, output a second sound to the audio output device based on a second audio signal received based on the transition to the external input mode, and transmit a third audio signal or a mute signal to the sound output device. Accordingly, when the image display apparatus outputs sound, the sense of discrepancy caused by other sounds from the sound output device can be reduced. Furthermore, when the image display apparatus outputs sound independently, stable sounds can be output.

Meanwhile, in response to the external input mode being switched to a simultaneous sound output mode with the sound output device, the signal processing device can be configured to transmit a third audio signal corresponding to the second audio signal to the sound output device. Accordingly, when the image display apparatus outputs sound, the sense of discrepancy caused by other sounds from the sound output device can be reduced.

Meanwhile, the interface can be wired to the sound output device via an HDMI interface, receive a first video signal and a first audio signal from the sound output device in a first input mode, and transmit the third audio signal or the mute signal to the sound output device in a second input mode to which the external input mode has been switched. Accordingly, when the image display apparatus outputs sound, the sense of discrepancy caused by other sounds from the sound output device can be reduced.

Meanwhile, the interface can be wired to the sound output device via an HDMI interface, receive the first video signal and the first audio signal from the sound output device through a plurality of Transition Minimized Differential Signaling (TMDS) lanes in the first input mode, and transmit the third audio signal or the mute signal to the sound output device through a subset of the plurality of TMDS lanes or a utility line in the second input mode to which the external input mode has been switched. Accordingly, when the image display apparatus outputs sound, the sense of discrepancy caused by other sounds from the sound output device can be reduced.

Meanwhile, the interface can be wired to the sound output device via an HDMI interface, receive the first video signal and the first audio signal from the sound output device through a plurality of Fixed Rate Link (FRL) lanes in the first input mode, and transmit the third audio signal or the mute signal to the sound output device through a subset of the plurality of FRL lanes or a utility line in the second input mode to which the external input mode has been switched. Accordingly, when the image display apparatus outputs sound, the sense of discrepancy caused by other sounds from the sound output device can be reduced.

Meanwhile, the interface can be configured to receive information on the sound output device through a CEC line in response to the sound output device being powered on. Accordingly, when the image display apparatus outputs sound, the sense of discrepancy caused by other sounds from the sound output device can be reduced.

Meanwhile, in response to the external input mode being switched, the signal processing device can be configured to transmit the mute signal to the sound output device in response to the image display apparatus being in a standalone sound output mode or in response to transmission of an audio return channel signal to the sound output device being not possible. Accordingly, when the image display apparatus outputs sound, the sense of discrepancy caused by other sounds from the sound output device can be reduced.

Meanwhile, the interface can include a first HDMI terminal and a second HDMI terminal, the first HDMI terminal can be configured to receive the first video signal and the first audio signal from the sound output device in the first input mode, and the second HDMI terminal can be configured to receive the second image signal and the second audio signal from a connected external device in the second input mode to which the external input mode has been switched. Accordingly, when the image display apparatus outputs sound, the sense of discrepancy caused by other sounds from the sound output device can be reduced.

Meanwhile, in the second input mode, in response to the simultaneous sound output mode with the sound output device being set and signal transmission via the audio return channel to the sound output device being possible, the first HDMI terminal can be configured to transmit the third audio signal corresponding to the second audio signal to the sound output device. Accordingly, when the image display apparatus outputs sound, the sense of discrepancy caused by other sounds from the sound output device can be reduced.

Meanwhile, in the second input mode, in response to a common sound output mode being set, the signal processing device can be configured to control the sound output, the sound output device, and the external device to output sound respectively; in the second input mode, in response to a first simultaneous sound output mode being set, the signal processing device can be configured to control the image display apparatus and the external device to output sound respectively; and in the second input mode, in response to a second simultaneous sound output mode being set, the signal processing device can be configured to control the image display apparatus and the sound output device to output sound respectively. Accordingly, when the image display apparatus outputs sound, the sense of discrepancy caused by other sounds from the sound output device can be reduced.

Meanwhile, the interface can include a first HDMI terminal configured to support an audio return channel and a second HDMI terminal configured to not support the audio return channel; in response to an external device being connected to the first HDMI terminal and the sound output device is connected to the second HDMI terminal, in the first input mode, the first HDMI terminal can be configured to receive the first video signal and the first audio signal from the sound output device through the second HDMI terminal; and in the second input mode to which the external input mode has been switched, the first HDMI terminal can be configured to receive the second image signal and the second audio signal from a connected external device, while the second HDMI terminal can not transmit the third audio signal or the mute signal to the sound output device. Accordingly, when the image display apparatus outputs sound, the sense of discrepancy caused by other sounds from the sound output device can be reduced.

An image display apparatus according to another embodiment of the present disclosure comprises a display, an audio output device configured to output sound, an interface configured to receive signal from an external sound output device, and a signal processing device configured to display a first image on the display based on a first video signal received from a settop device and output a first sound to the audio output device based on a first audio signal received from the settop device, wherein in response to the external input mode being switched, the signal processing device is configured to display a second image on the display based on a second image signal received based on the transition to the external input mode, output a second sound to the audio output device based on a second audio signal received based on the transition to the external input mode, and transmit a mute signal to the settop device or the sound output device connected to the settop device. Accordingly, when the image display apparatus outputs sound, the sense of discrepancy caused by other sounds from the sound output device can be reduced. Furthermore, when the image display apparatus outputs sound independently, stable sounds can be output.

Meanwhile, the interface can be wired to the settop device via an HDMI interface, receive the first video signal and the first audio signal from the settop device in a first input mode, and transmit the mute signal to the settop device in a second input mode to which the external input mode has been switched. Accordingly, when the image display apparatus outputs sound, the sense of discrepancy caused by other sounds from the sound output device can be reduced.

Meanwhile, the interface can be wired to the settop device via an HDMI interface, receive the first video signal and the first audio signal from the settop device through a plurality of Transition Minimized Differential Signaling (TMDS) lanes in the first input mode, and transmit the mute signal to the settop device through a subset of the plurality of TMDS lanes or a utility line in the second input mode to which the external input mode has been switched. Accordingly, when the image display apparatus outputs sound, the sense of discrepancy caused by other sounds from the sound output device can be reduced.

Meanwhile, the interface can be wired to the settop device via an HDMI interface, receive the first video signal and the first audio signal from the settop device through a plurality of Fixed Rate Link (FRL) lanes in the first input mode, and transmit the mute signal to the settop device through a subset of the plurality of FRL lanes or a utility line in the second input mode to which the external input mode has been switched. Accordingly, when the image display apparatus outputs sound, the sense of discrepancy caused by other sounds from the sound output device can be reduced.

Meanwhile, the interface can be configured to receive information on the settop device through a CEC line in response to the settop device being powered on. Accordingly, when the image display apparatus outputs sound, the sense of discrepancy caused by other sounds from the sound output device can be reduced.

Meanwhile, the interface can include a first HDMI terminal and a second HDMI terminal, the first HDMI terminal can be configured to receive the first video signal and the first audio signal from the settop device in the first input mode, and the second HDMI terminal can be configured to receive the second image signal and the second audio signal from a connected external device in the second input mode to which the external input mode has been switched. Accordingly, when the image display apparatus outputs sound, the sense of discrepancy caused by other sounds from the sound output device can be reduced.

Meanwhile, the interface can include a first HDMI terminal configured to support an audio return channel and a second HDMI terminal configured to not support the audio return channel; in response to an external device being connected to the first HDMI terminal and the settop device is connected to the second HDMI terminal, in the first input mode, the first HDMI terminal can be configured to receive the first video signal and the first audio signal from the settop device through the second HDMI terminal; and in the second input mode to which the external input mode has been switched, the first HDMI terminal can be configured to receive the second image signal and the second audio signal from a connected external device, while the second HDMI terminal can not transmit the third audio signal or the mute signal to the settop device. Accordingly, when the image display apparatus outputs sound, the sense of discrepancy caused by other sounds from the sound output device can be reduced.

While the disclosure has been described with reference to the embodiments, the disclosure is not limited to the above-described specific embodiments, and it will be understood by those skilled in the related art that various modifications and variations can be made without departing from the scope of the disclosure as defined by the appended claims, as well as these modifications and variations should not be understood separately from the technical spirit and prospect of the disclosure.

What is claimed is:

1. An image display apparatus comprising:
a display;
an audio output device configured to output sound;
an interface configured to receive signal from an external sound output device; and
a signal processing device configured to display a first image on the display based on a first video signal received from the sound output device and output a first sound to the audio output device based on a first audio signal received from the sound output device,
wherein in response to the external input mode being switched, the signal processing device is configured to display a second image on the display based on a second image signal received based on the transition to the external input mode, output a second sound to the audio output device based on a second audio signal received based on the transition to the external input mode, and transmit a third audio signal or a mute signal to the sound output device.

2. The apparatus of claim 1, wherein, in response to the external input mode being switched to a simultaneous sound output mode with the sound output device, the signal processing device is configured to transmit a third audio signal corresponding to the second audio signal to the sound output device.

3. The apparatus of claim 1, wherein the interface is wired to the sound output device via an HDMI interface, and
wherein the interface is configured to receive a first video signal and a first audio signal from the sound output device in a first input mode, and transmit the third audio signal or the mute signal to the sound output device in a second input mode to which the external input mode has been switched.

4. The apparatus of claim 1, wherein the interface is wired to the sound output device via an HDMI interface, and
wherein the interface is configured to receive the first video signal and the first audio signal from the sound output device through a plurality of Transition Minimized Differential Signaling (TMDS) lanes in the first input mode, and transmit the third audio signal or the mute signal to the sound output device through a subset of the plurality of TMDS lanes or a utility line in the second input mode to which the external input mode has been switched.

5. The apparatus of claim 1, wherein the interface is wired to the sound output device via an HDMI interface, and
wherein the interface is configured to receive the first video signal and the first audio signal from the sound output device through a plurality of Fixed Rate Link (FRL) lanes in the first input mode, and transmit the third audio signal or the mute signal to the sound output device through a subset of the plurality of FRL lanes or a utility line in the second input mode to which the external input mode has been switched.

6. The apparatus of claim 4, wherein the interface is configured to receive information on the sound output device through a CEC line in response to the sound output device being powered on.

7. The apparatus of claim 1, wherein, in response to the external input mode being switched, the signal processing device is configured to transmit the mute signal to the sound output device in response to the image display apparatus being in a standalone sound output mode or in response to transmission of an audio return channel signal to the sound output device being not possible.

8. The apparatus of claim 1, wherein the interface includes a first HDMI terminal and a second HDMI terminal,
wherein the first HDMI terminal is configured to receive the first video signal and the first audio signal from the sound output device in the first input mode, and
wherein the second HDMI terminal is configured to receive the second image signal and the second audio signal from a connected external device in the second input mode to which the external input mode has been switched.

9. The apparatus of claim 8, wherein, in the second input mode, in response to the simultaneous sound output mode with the sound output device being set and signal transmission via the audio return channel to the sound output device being possible, the first HDMI terminal is configured to transmit the third audio signal corresponding to the second audio signal to the sound output device.

10. The apparatus of claim 8, wherein, in the second input mode, in response to a common sound output mode being set, the signal processing device is configured to control the audio output device, the sound output device, and the external device to output sound respectively,
in the second input mode, in response to a first simultaneous sound output mode being set, control the image display apparatus and the external device to output sound respectively, and
in the second input mode, in response to a second simultaneous sound output mode being set, the signal processing device is configured to control the image display apparatus and the sound output device to output sound respectively.

11. The apparatus of claim 1, wherein the interface includes a first HDMI terminal configured to support an audio return channel and a second HDMI terminal configured to not support the audio return channel,
in response to an external device being connected to the first HDMI terminal and the sound output device is connected to the second HDMI terminal, in the first input mode, the first HDMI terminal is configured to receive the first video signal and the first audio signal from the sound output device through the second HDMI terminal, and
in the second input mode to which the external input mode has been switched, the first HDMI terminal is configured to receive the second image signal and the second audio signal from a connected external device, while the second HDMI terminal does not transmit the third audio signal or the mute signal to the sound output device.

12. An image display apparatus comprising:
a display;
an audio output device configured to output sound;
an interface configured to receive signal from an external sound output device; and
a signal processing device configured to display a first image on the display based on a first video signal received from a settop device and output a first sound to the audio output device based on a first audio signal received from the settop device,
wherein in response to the external input mode being switched, the signal processing device is configured to display a second image on the display based on a second image signal received based on the transition to the external input mode, output a second sound to the audio output device based on a second audio signal received based on the transition to the external input mode, and transmit a mute signal to the settop device or the sound output device connected to the settop device.

13. The apparatus of claim 12, wherein the interface is wired to the settop device via an HDMI interface, and
wherein the interface is configured to receive the first video signal and the first audio signal from the settop device in a first input mode, and transmit the mute signal to the settop device in a second input mode to which the external input mode has been switched.

14. The apparatus of claim 12, wherein the interface is wired to the settop device via an HDMI interface, and
wherein the interface is configured to receive the first video signal and the first audio signal from the settop device through a plurality of Transition Minimized Differential Signaling (TMDS) lanes in the first input mode, and transmit the mute signal to the settop device through a subset of the plurality of TMDS lanes or a utility line in the second input mode to which the external input mode has been switched.

15. The apparatus of claim 12, wherein the interface is wired to the settop device via an HDMI interface, and
wherein the interface is configured to receive the first video signal and the first audio signal from the settop device through a plurality of Fixed Rate Link (FRL) lanes in the first input mode, and transmit the mute signal to the settop device through a subset of the plurality of FRL lanes or a utility line in the second input mode to which the external input mode has been switched.

16. The apparatus of claim 14, wherein the interface is configured to receive information on the settop device through a CEC line in response to the settop device being powered on.

17. The apparatus of claim 12, wherein the interface includes a first HDMI terminal and a second HDMI terminal,
wherein the first HDMI terminal is configured to receive the first video signal and the first audio signal from the settop device in the first input mode, and
wherein the second HDMI terminal is configured to receive the second image signal and the second audio signal from a connected external device in the second input mode to which the external input mode has been switched.

18. The apparatus of claim 12, wherein the interface includes a first HDMI terminal configured to support an audio return channel and a second HDMI terminal configured to not support the audio return channel;
wherein in response to an external device being connected to the first HDMI terminal and the settop device is connected to the second HDMI terminal, in the first input mode, the first HDMI terminal is configured to receive the first video signal and the first audio signal from the settop device through the second HDMI terminal, and
wherein in the second input mode to which the external input mode has been switched, the first HDMI terminal is configured to receive the second image signal and the second audio signal from a connected external device, while the second HDMI terminal does not transmit the third audio signal or the mute signal to the settop device.
